(19) United States
(12) Patent Application Publication
(10) Pub. No.: US 2023/0149134 A1
(43) Pub. Date: May 18, 2023

(54) APPARATUS FOR ATTACHING A DEVICE TO DENTITION

(71) Applicant: VisionX, LLC, Edina, MN (US)

(72) Inventors: Michael C. Marshall, Edina, MN (US); Bruce Willard Hultgren, Victoria, MN (US); Steven M. Rzepecki, Eden Prairie, MN (US)

(21) Appl. No.: 17/919,383

(22) PCT Filed: Apr. 15, 2021
(86) PCT No.: PCT/US2021/027472

§ 371 Date: Oct. 17, 2022

Related U.S. Application Data
(60) Provisional application No. 63/066,817, filed on Aug. 18, 2020.
(60) Provisional application No. 63/010,514, filed on Apr. 15, 2020.

(51) Int. Cl. A61C 9/00; A61C 19/045

(52) U.S. Cl. CPC A61C 9/0046; A61C 19/045

(57) ABSTRACT

Apparatuses, components, devices, methods, and systems for coupling to a patients dentition are provided. An example apparatus includes a base region, an extension member connected to the base region, a first arm configured to couple to a first side of the patients dentition, a second arm configured to couple to a second side of the patients dentition. The extension member is configured to protrude out from the patients mouth and includes an includes an attachment assembly for removably connecting with a position indicator system. The apparatus may include a registration tool that removably couples the position indicator system and includes a scan end configured to be scanned with the patients dentition. The apparatus may include a removable alignment apparatus that includes at least one dentition fitting surface configured to fit to a surface of the patients dentition.

### CROSS REFERENCE TO RELATED APPLICATIONS

This application claims priority, as appropriate, to U.S. Ser. No. 63/010,514, titled “CLUTCH APPARATUS FOR ATTACHING A DEVICE TO DENTITION” and filed Apr. 15, 2020, and U.S. Ser. No. 63/066,817, titled “ALIGNMENT APPARATUS FOR ATTACHING A DEVICE TO DENTITION” and filed Aug. 18, 2020, the disclosures of which are hereby incorporated by reference in their entireties.

### BACKGROUND

Understanding and recording an accurate static relationship between teeth in a patient's upper jaw and lower jaw is an important first step in the art and science of designing dental appliances or restorations and planning dental or surgical interventions that affect dental/skeletal function and aesthetics of the facial musculature system.

Additionally, the dynamic motion of the lower jaw and dentition interacting functionally and aesthetically is even more important in the various reconstructive domains in dentistry and medicine that require precise knowledge and locations of the musculoskeletal-dental components that define this motion. The greater accuracy of motion definition allows for more precise design of restorations (e.g., crowns, implants, full/partial prosthesis) and associated macro procedures such as orthognathic surgery, trauma reconstruction, etc. These physical components can be described in engineering terms as a kinematic linkage system incorporating the relationship of the temporomandibular joint to the dentition and soft tissue of the face. This linkage definition has only been approximated poorly by traditional articulator devices and systems in dentistry.

Dental appliances may be used in the treatment of various dental conditions. Examples of dental appliances include therapeutic appliances and restorative appliances (dental restorations). Non-limiting examples of therapeutic appliances include surgical splints, occlusal splints, orthodontic retainers, and orthodontic aligners. A dental restoration is a type of dental appliance that is used to restore a tooth or multiple teeth. For example, a crown is a dental restoration that is used to restore a single tooth. A bridge is another example of a dental restoration. A bridge may be used to restore one or more teeth. A denture is another example of a dental restoration. A denture can be a full or partial denture. Dentures can also be fixed or removable. An implant is yet another example of a dental restoration. Dental implants are prosthetic devices that are placed in bone tissue of a patient's jaw and used to secure other dental restorations such as implant abutments and crowns, or partial and full dentures. In some circumstances, dental restorations are used to restore functionality after a tooth is damaged. In other circumstances, dental restorations are used to aesthetically improve a patient's dentition.

When complex or multiple dental appliances, dental restorations, or dental therapies are applied to a patient simultaneously, errors or inaccuracies in the representation of dental motion are compounded, resulting in inadequate or suboptimal results for patients. In the worst case, inaccurate motion data can result in the complete failure of the appliances, restorations, or treatment at very high cost clinically, financially, and emotionally.

Jaw and facial movement may be determined by attaching a device to the patient's dentition.

### SUMMARY

In general terms, this disclosure is directed to a system for measuring jaw movement. In one possible configuration and by non-limiting example, a patient assembly is coupled to a patient's dentition and an imaging system captures images of the patient assembly as the patient's dentition moves. The patient assembly may be aligned to the patient's dentition using a custom alignment apparatus.

One aspect is an apparatus comprising: a base region; an extension member connected to the base region and configured to protrude out from a patient's mouth, the extension member including an attachment assembly for removably connecting with a position indicator system; a first arm configured to couple to a first side of the patient's dentition; and a second arm configured to couple to a second side of the patient's dentition.

Yet another aspect is a method comprising: capturing three-dimensional scan data of a first dental arch of a patient; generating an alignment apparatus for the first dental arch based on the captured three-dimensional scan data; aligning a first dentition coupling device to the first dental arch using the alignment apparatus; securing the first dentition coupling device to the first dental arch; removing the alignment apparatus; capturing motion data of a first position indicator system coupled to the first dentition coupling device; and determining motion of the first dental arch based on the captured motion data of the first position indicator system.

Another aspect is a method comprising: coupling a dentition coupling device of a clutch to a first dental arch of a patient's dentition; attaching a registration tool to a position indicator system of the clutch; capturing three-dimensional scan data that includes a portion of the first dental arch and at least a portion of the registration tool; and determining the position of the registration tool relative to the first dental arch based on the three-dimensional scan data.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

FIG. 1 is a schematic block diagram illustrating an example motion capture system for capturing jaw movement.

FIG. 2 illustrates a block diagram of an example patient assembly of FIG. 1.

FIG. 3 illustrates an example embodiment of the clutch of FIG. 2.

FIG. 4 is a top view of a schematic diagram of an embodiment of a dentition coupling device of the clutch or reference structure of FIG. 2.

FIG. 5 is a schematic diagram of an embodiment of an attachment assembly of the dentition coupling device of FIG. 4 and an embodiment of a corresponding attachment assembly of a position indicator system.

FIG. 6 shows an example of the dentition coupling device of FIG. 4 in contact with a patient's dentition.

FIG. 7 is a top view of a schematic diagram of an embodiment of a dentition coupling device of the clutch or reference structure of FIG. 2.

FIG. 8 is a top view of a schematic diagram of an embodiment of a dentition coupling device of the clutch or reference structure of FIG. 2.

FIG. 9 is a top view of a schematic diagram of an embodiment of a dentition coupling device of the clutch or reference structure of FIG. 2.

FIG. 10A is a top view of a schematic diagram of an embodiment of a dentition coupling device of the clutch or reference structure of FIG. 2.

FIG. 10B is a schematic diagram of the bonding block of FIG. 10A.

FIGS. 11A-B are cross-sectional side views that illustrate the attachment of an embodiment of a dentition coupling device of the clutch or reference structure of FIG. 2 to a dental implant.

FIG. 12 is a schematic diagram of an embodiment of a dentition coupling device of the clutch or reference structure of FIG. 2.

FIG. 13 is a schematic diagram of an embodiment of a dentition coupling device of the clutch or reference structure of FIG. 2.

FIG. 14 is a schematic diagram of an embodiment of a dentition coupling device of the clutch or reference structure of FIG. 2.

FIGS. 15A-B are schematic diagrams of an embodiment of a dentition coupling device of the clutch or reference structure of FIG. 2.

FIG. 16 is a schematic diagram of a profile view of an embodiment of a dentition coupling device of the clutch or reference structure of FIG. 2.

FIG. 17 is a schematic block diagram illustrating an example of a system for using jaw motion captured by the system of FIG. 1 to fabricate a dental appliance or provide dental therapy.

FIG. 18 includes an example of the motion capture system of FIG. 1 in which two screens are used.

FIG. 19 illustrates a top view of an embodiment of the reference structure of FIG. 18 and an embodiment of the imaging system of FIG. 1.

FIG. 20 illustrates a perspective view of the reference structure of FIG. 18 disposed between the screens of the imaging system of FIG. 18.

FIG. 21 is a side view of a schematic diagram of an embodiment of a dentition coupling and alignment system.

FIG. 22 is a side view of a schematic diagram of an embodiment of a dentition coupling and alignment system.

FIG. 23 is a flowchart of an example process for capturing and using jaw motion.

FIG. 24A is an isometric view of an embodiment of a position indicator system.

FIG. 24B is a bottom view of the position indicator system of FIG. 24A.

FIG. 25A is an isometric view of an example registration tool.

FIG. 25B is a top view of the registration tool of FIG. 25A.

FIG. 25C is a front view of the registration tool of FIG. 25A.

FIG. 25D is a side view of the registration tool of FIG. 25A.

FIG. 25E is a top view of the registration tool of FIG. 25A.

FIG. 26A is an isometric view of an example registration tool coupled to a position indicator system.

FIG. 26B is a top view of the example registration tool coupled to the position indicator system of FIG. 26A;

FIG. 26C is a side view of the example registration tool coupled to the position indicator system of FIG. 26A.

FIG. 26D is a bottom view of the example registration tool coupled to the position indicator system of FIG. 26A.

FIG. 27 is an isometric view of an example dentition coupling device.

FIG. 28A is an isometric view of a patient's dentition with a dentition coupling device, a position indicator system, and a registration tool.

FIG. 28B is a side view of the patient's dentition with the dentition coupling device, the position indicator system, and the registration tool of FIG. 28A.

FIG. 29 illustrates an example architecture of a computing device, which can be used to implement aspects according to the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates to dentition coupling devices. For example, the dentition coupling device may couple an apparatus to the dentition of a patient. In some implementations, the dentition coupling device is reusable and includes elements that may be adjusted to couple to the dentition of many patients. In some implementations, the dentition coupling device is custom fabricated to fit the dentition of a specific patient. For example, the dentition coupling device may include one or more components that are fabricated based on a digital impression of a specific patient's dentition.

The dentition coupling device may be usable with a jaw movement measurement system. For example, the system may record the motion of a patient's mandible relative to the patient's maxilla. In some embodiments, the system operates to infer the approximate location of a screw axis corresponding to the condyloid process of the temporomandibular joint of the patient. Further, the system may generate a model of a range of motion of the mandible relative to the maxilla based on the inferred location of the screw axis, the recorded motion, or both. By securely coupling to the patient's dentition, the dentition coupling device may allow for more accurate and repeatable capture of patient jaw movement.

In embodiments, the recorded motion is applied to a three-dimensional digital model of at least a portion of the patient's dentition. This motion can then be used while designing dental appliances or planning various dental therapies for the patient. In this manner, the appliances and therapies can be designed based on analysis of a range of actual motion for the patient. This may be especially beneficial when designing complex restorations such as bridges, implants, or implant-supported prosthesis for the treatment of edentulous or partially edentulous dentitions as well as in providing dental therapies such as oral-maxillofacial reconstructive surgery.

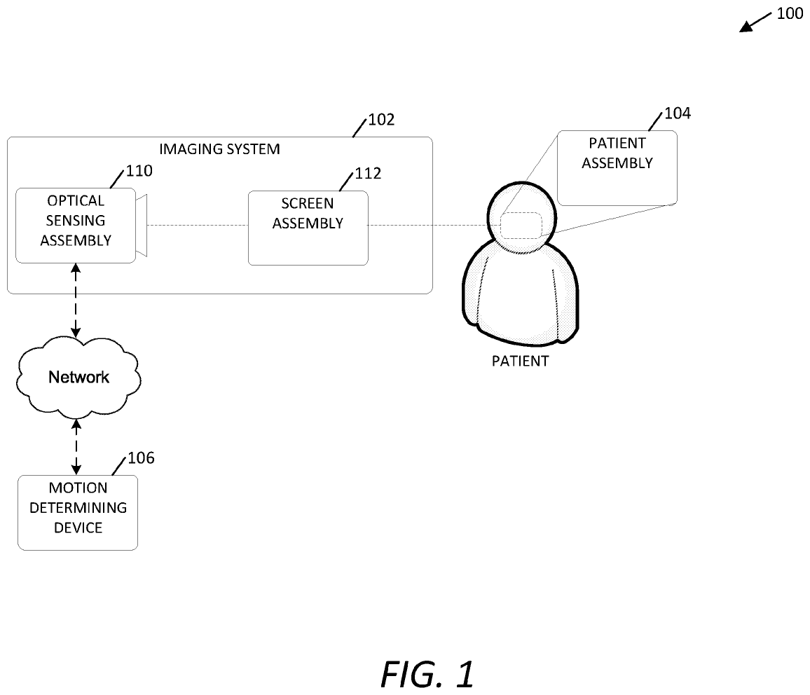

FIG. 1 is a schematic block diagram illustrating an example motion capture system 100 for capturing jaw movement. In this example, the motion capture system 100 includes an imaging system 102, a patient assembly 104, and a motion determining device 106. Also shown in FIG. 1 are a patient and a network.

In some embodiments, the imaging system 102 includes an optical sensing assembly 110 and a screen assembly 112. The optical sensing assembly 110 may capture a plurality of images as the patient's jaw moves. For example, the optical sensing assembly 110 may include one or more cameras such as video cameras. In some embodiments, the optical sensing assembly 110 captures a plurality of images that do not necessarily include the patient assembly, but can be used to determine the position of the patient assembly 104. For example, the patient assembly 104 may emit lights that project onto surfaces of the screen assembly 112 and the optical sensing assembly 110 may capture images of those surfaces of the screen assembly 112. In some implementations, the optical sensing assembly 110 does not capture images but otherwise determines the position of the projected light or lights on the surfaces of the screen assembly 112.

The screen assembly 112 may include one or more screens. A screen may include any type of surface upon which light may be projected. Some implementations include flat screens that have a planar surface. Some implementations may include rounded screens, having cylindrical (or partially cylindrical) surfaces. The screens may be formed from a translucent material. For example, the locations of the lights projected on the screens of the screen assembly 112 may be visible from a side of the screens opposite the patient assembly 104 (e.g., the screen assembly 112 may be positioned between the optical sensing assembly 110 and the patient assembly 104).

In addition to capturing the images, the imaging system 102 may capture or generate various information about the images. As an example, the imaging system 102 can generate timing information about the images. Although alternatives are possible, the timing information can include a timestamp for each of the images. Alternatively or additionally, a frame rate (e.g., 10 frames/second, 24 frames/second, 60 frames/second) is stored with a group of images. Other types of information that can be generated for the images includes an identifier of a camera, a position of a camera, or settings used when capturing the image.

The patient assembly 104 is an assembly that is configured to be secured to the patient. The patient assembly 104 or parts thereof may be worn by the patient and may move freely with the patient (i.e., at least a part of the patient assembly 104 may, when mounted to the patient, move in concert with patient head movement). In contrast, in at least some implementations, the imaging system 102 is not mounted to the patient and does not move in concert with patient head movement.

In some embodiments, the patient assembly 104 may include light emitters that emit a pattern of light that projects on one or more surfaces (e.g., screens of the screen assembly 112), which can be imaged to determine the position of the patient assembly 104. For example, the light emitters may emit beams of substantially collimated light (e.g., laser beams) that project onto the surfaces as points. Based on the locations of these points on the surfaces, a coordinate system can be determined for the patient assembly 104, which can then be used to determine a position and orientation of the patient assembly 104 and the patient's dentition.

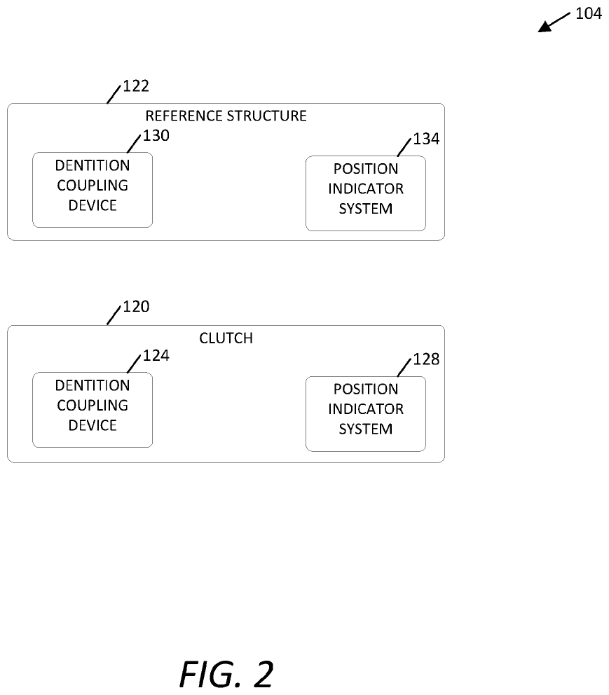

In some embodiments, the patient assembly 104 includes separate components that are configured to be worn on the upper dentition and the lower dentition and to move independently of each other so that the motion of the lower dentition relative to the upper dentition can be determined. Examples of the patient assembly 104 are illustrated and described throughout, including in FIG. 2.

The motion determining device 106 determines the motion of the patient assembly 104 based on images captured by the imaging system 102. In some embodiments, the motion determining device 106 includes a computing device that uses image processing techniques to determine three-dimensional coordinates of the patient assembly 104 (or portions of the patient assembly) as the patient's jaw is in different positions. For example, images captured by the optical sensing assembly 110 of screens of the screen assembly 112 may be processed to determine the positions on the screens at which light from the patient assembly is projected. These positions on the screens of the screen assembly 112 may be converted to three-dimensional coordinates with respect to the screen assembly 112. From those three-dimensional coordinates, one or more positions and orientations of the patient assembly 104 (or components of the patient assembly 104) may be determined.

Based on the determined positions and orientations of the patient assembly 104, some embodiments determine the relative positions and movements of the patient's upper and lower dentition. Further, some embodiments infer the location of a kinematically derived screw axis that is usable in modeling the motion of the patient's mandible (including the lower dentition) about the temporomandibular joint.

FIG. 2 illustrates a block diagram of an example patient assembly 104. In this example, the patient assembly includes a clutch 120 and a reference structure 122. Here, the clutch 120 and the reference structure 122 are not physically connected and can move independently of one another.

The clutch 120 is a device that is configured to couple to a patient's dentition. For example, the clutch 120 may grip the teeth of the dentition of the patient. In some embodiments, the clutch 120 comprises a dentition coupling device 124 and a position indicator system 128. In some embodiments, the clutch 120 is configured to couple to the lower dentition of the patient so as to move with the patient's mandible. In other embodiments, the clutch 120 may be configured to couple to the patient's upper dentition so as to move with the patient's maxilla.

The dentition coupling device 124 is configured to removably couple to the patient's dentition. In some embodiments, the dentition coupling device 124 rigidly couples to the patient's dentition such that while coupled, the movement of the dentition coupling device 124 relative to the patient's dentition is minimized. Various embodiments include various coupling mechanisms.

For example, some embodiments couple to the patient's dentition using brackets that are adhered to the patient's teeth with a dental or orthodontic adhesive. As another example, some embodiments couple to the patient's dentition using an impression material. For example, some embodiments of the dentition coupling device 124 comprise an impression tray and an impression material such as polyvinyl siloxane. To couple the dentition coupling device 124 to the patient's dentition, the impression tray is filled with impression material and then placed over the patient's dentition. As the impression material hardens, the dentition coupling device 124 couples to the patient's dentition.

Alternatively, some embodiments comprise a dentition coupling device 124 that is custom designed for a patient based on a three-dimensional model of the patient's dentition. For example, the dentition coupling device 124 may be formed using a rapid fabrication machine. One example of a rapid fabrication machine is a three-dimensional printer, such as the PROJET® line of printers from 3D Systems, Inc. of Rock Hill, S.C. Another example of a rapid fabrication machine is a milling device, such as a computer numerically controlled (CNC) milling device. In these embodiments, the dentition coupling device 124 may comprise various mechanical retention devices such as clasps that are configured to fit in an undercut region of the patient's dentition.

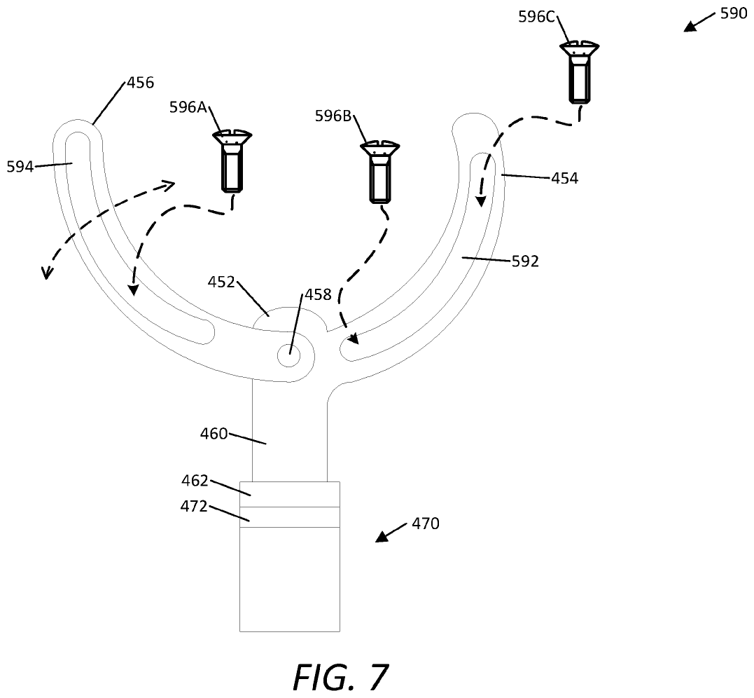

Embodiments of the dentition coupling device 124 may be operable to couple to the patient's dentition using a combination of one or more mechanical retention structures, adhesives, and impression materials. For example, the dentition coupling device 124 may include apertures through which a fastening device (also referred to as a fastener) such as a temporary anchorage device may be threaded to secure the dentition coupling device 124 to the patient's dentition, gum tissue, or underlying bone tissue. For example, the temporary anchorage devices may screw into the patient's bone tissue to secure the dentition coupling device 124. An example of a dentition coupling device that may be secured using a temporary anchorage device is illustrated and described with respect to at least FIG. 7.

In some embodiments, the dentition coupling device 124 includes one or more fiducial markers, such as hemispherical inserts, that can be used to establish a static relationship between the position of the clutch 120 and the patient's dentition. For example, the dentition coupling device 124 may include three fiducial markers disposed along its surface. The location of these fiducial markers can then be determined relative to the patient's dentition such as by capturing a physical impression of the patient with the clutch attached or using imaging techniques such as capturing a digital impression (e.g., with an intraoral scanner) or other types of images of the dentition and fiducial markers. Some embodiments of the dentition coupling device 124 do not include fiducial markers. One or more images or a digital impression of the patient's dentition captured while the dentition coupling device 124 is mounted may be aligned to one or more images or a digital impression of the patient's dentition captured while the dentition coupling device 124 is not mounted.

The position indicator system 128 is a system that is configured to be used to determine the position and orientation of the clutch 120. In some embodiments, the position indicator system 128 includes multiple fiducial markers. In some examples, the fiducial markers are spheres. Spheres work well as fiducial markers because the location of the center of the sphere can be determined in an image regardless of the angle from which the image containing the sphere was captured. The multiple fiducial markers may be disposed (e.g., non-collinearly) so that by determining the locations of each (or at least three) of the fiducial markers, the position and orientation of the clutch 120 can be determined. For example, these fiducial markers may be used to determine the position of the position indicator system 128 relative to the dentition coupling device 124, through which the position of the position indicator system 128 relative to the patient's dentition can be determined.

Some implementations of the position indicator system 128 do not include separate fiducial markers. In at least some of these implementations, structural aspects of the position indicator system 128 may be used to determine the position and orientation of the position indicator system 128. For example, one or more flat surfaces, edges, or corners of the position indicator system 128 may be imaged to determine the position and orientation of the position indicator system 128. In some implementations, an intraoral scanner is used to capture a three-dimensional model (or image) that includes a corner of the position indicator system 128 and at least part of the patient's dentition while the dentition coupling device 124 is mounted. This three-dimensional model can then be used to determine a relationship between the position indicator system 128 and the patient's dentition. The determined relationship may be a static relationship that defines the position and orientation of the position indicator system 128 relative to a three-dimensional model of the patient's dentition (e.g., based on the corner of the position indicator system 128 that was captured by the intraoral scanner).

In some embodiments, the position indicator system 128 includes a light source assembly that emits beams of light. The light source assembly may emit substantially collimated light beams (e.g., laser beams). In some embodiments, the light source assembly is rigidly coupled to the dentition coupling device 124 so that as the dentition coupling device 124 moves with the patient's dentition, the beams of light move. The position of the dentition coupling device 124 is then determined by capturing images of where the light beams intersect with various surfaces (e.g., translucent screens disposed around the patient). Embodiments that include a light source assembly are illustrated and described throughout.

The reference structure 122 is a structure that is configured to be worn by the patient so as to provide a point of reference to measure the motion of the clutch 120. In embodiments where the clutch 120 is configured to couple to the patient's lower dentition, the reference structure 122 is configured to mount elsewhere on the patient's head so that the motion of the clutch 120 (and the patient's mandible) can be measured relative to the rest of the patient's head. For example, the reference structure 122 may be worn on the upper dentition. Beneficially, when the reference structure 122 is mounted securely to the patient's upper dentition, the position of the reference structure 122 will not be impacted by the movement of the mandible (e.g., muscle and skin movement associated with the mandibular motion will not affect the position of the reference structure 122). Alternatively, the reference structure 122 may be configured to be worn elsewhere on the patient's face or head.

In some embodiments, the reference structure 122 is similar to the clutch 120 but configured to be worn on the dental arch opposite the clutch (e.g., the upper dentition if the clutch 120 is for the lower dentition). For example, the reference structure 122 shown in FIG. 2 includes a dentition coupling device 130 that may be similar to the dentition coupling device 124, and a position indicator system 134 that may be similar to the position indicator system 128.

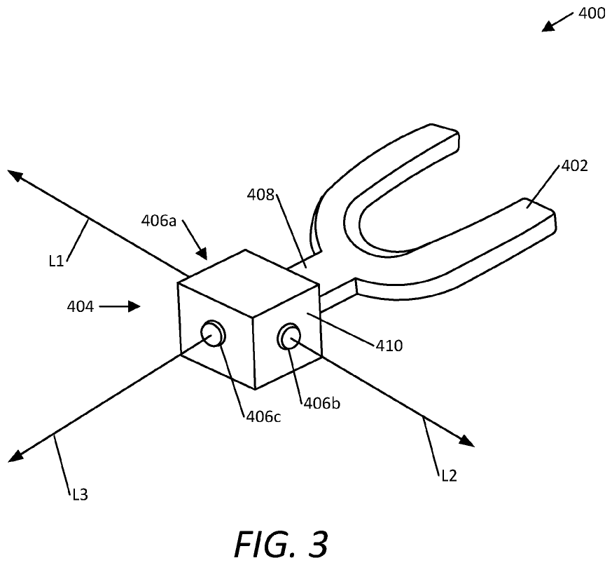

FIG. 3 illustrates an embodiment of a clutch 400. The clutch 400 is an example of the clutch 120. In this example, the clutch 400 includes a dentition coupling device 402 and a light source assembly 404, and an extension member 408. The dentition coupling device 402 is an example of the dentition coupling device 124, and the light source assembly 404 is an example of the position indicator system 128.

The light source assembly 404, which may also be referred to as a projector, is a device that emits light beams comprising light that is substantially collimated. Collimated light travels in one direction. A laser beam is an example of collimated light. In some embodiments, the light source assembly 404 includes one or more lasers. Although alternatives are possible, the one or more lasers may be semiconductor lasers such as laser diodes or solid-state lasers such as diode-pumped solid-state lasers.

In some embodiments, the light source assembly 404 comprises a first, second, and third light emitter. The first and second light emitters may emit substantially collimated light in parallel but opposite directions (i.e., the first and second light emitters may emit light in antiparallel directions) such as to the left and right of the patient when the clutch 400 is coupled to the patient's dentition. In some embodiments, the first and second light emitters are collinear or are substantially collinear (e.g., offset by a small amount such as less than 5 micrometers, less than 10 micrometers, less than 25 micrometers, less than 50 micrometers, or less than 100 micrometers). The third light emitter may emit substantially collimated light in a direction of a line that intersects with or substantially intersects with lines corresponding to the direction of the first and second light emitters. Lines that intersect share a common point. Lines that substantially intersect do not necessarily share a common point, but would intersect if offset by a small amount such as less than 5 micrometers, less than 10 micrometers, less than 25 micrometers, less than 50 micrometers, or less than 100 micrometers. In some embodiments, the third light emitter emits light in a direction that is perpendicular to the first and second light emitters, such as toward the direction the patient is facing.

In some embodiments, the third light emitter emits light in a direction that is offset from the direction of the first light emitter so as to be directed toward the same side of the patient as the direction of the first light emitter. For example, the third light emitter may be offset from the first light emitter by an offset angle of less than 90 degrees such that the light emitted by both the first light emitter and the second light emitter intersect with the same screen (e.g., a planar screen having a rectangular shape and being disposed on a side of the patient). The third light emitter may be offset from the first light emitter by an offset angle of between approximately 1 degree to 45 degrees. In some implementations, the offset angle is between 3 degrees and 30 degrees. In some implementations, the offset angle is between 5 degrees and 15 degrees. For example, the offset angle may be less than 10 degrees.

In some embodiments, one or more compensation factors are determined to compensate for an offset from the first and second light emitters being collinear, or an offset from the third light emitter emitting light in a direction of a line that intersects with the directions of the first and second light sources. A compensation factor may also be determined for the offset angle of the third light emitter with respect to the first and second light emitters. For example, an offset angle compensation factor may specify the angle between the direction of the third light emitter and a line defined by the first light emitter. In implementations in which the orientation of the third light emitter is directed perpendicular to or substantially perpendicular to the direction of the first light emitter, the offset angle compensation factor may be 90 degrees or approximately 90 degrees. In implementations in which the orientation of the third light emitter is directed toward a side of the patient, the offset angle compensation factor may, for example, be between approximately 5 and 45 degrees. The compensation factors may be determined specifically for each position indicator system manufactured to account for minor variation in manufacturing and assembly. The compensation factors may be stored in a datastore (such as on the motion determining device 106 or on a computer readable medium accessible by the motion determining device 106). Each position indicator system may be associated with a unique identifier that can be used to retrieve the associated compensation factor. The position indicator system 134 may include a label with the unique identifier or a barcode, QR code, etc. that specifies the unique identifier.

Some embodiments of the light source assembly 404 include a single light source and use one or more beam splitters such as prisms or reflectors such as mirrors to cause that light source to function as multiple light emitters by splitting the light emitted by that light source into multiple beams. In at least some embodiments, the emitted light emanates from a common point. As another example, some embodiments of the light source assembly 404 may comprise apertures or tubes through which light from a common source is directed. Some embodiments may include separate light sources for each of the light emitters.

In the example of FIG. 3, the light source assembly 404 includes light emitters 406a, 406b, and 406c (referred to collectively as light emitters 406) and a housing 410. The light emitter 406a is emitting a light beam L1, the light emitter 406b is emitting a light beam L2, and the light emitter 406c is emitting a light beam L3. The light beams L1 and L2 are parallel to each other, but directed in opposite directions. The light beam L3 is perpendicular to the light beams L1 and L2. In at least some embodiments, the housing 410 is configured to position the light emitters 406 so that the light beams L1, L2, and L3 are approximately co-planar with the occlusal plane of the patient's dentition. Although the light beam L3 is perpendicular to the light beams L1 and L2 in the example of FIG. 3, alternatives are possible.

The housing 410 may be approximately cube shaped and includes apertures through which the light emitters 406 extend. In other embodiments, the light emitters do not extend through apertures in the housing 410 and instead light emitted by the light emitters 406 passes through apertures in the housing 410.

In the example of FIG. 3, the dentition coupling device 402 is rigidly coupled to the light source assembly 404 by an extension member 408. The extension member 408 extends from the dentition coupling device 402 and is configured to extend out of the patient's mouth when the dentition coupling device 402 is worn on the patient's dentition. In some embodiments, the extension member 408 is configured so as to be permanently attached to the light source assembly 404 such as by being formed integrally with the housing 410 or joined via welding or a permanent adhesive. In other embodiments, the extension member 408 is configured to removably attach to the light source assembly 404. Because the light source assembly 404 is rigidly coupled to the dentition coupling device 402, the position and orientation of the dentition coupling device 402 can be determined from the position and orientation of the light source assembly 404.

In some embodiments, the housing 410 and the dentition coupling device 402 are integral (e.g., are formed from a single material or are coupled together in a manner that is not configured to be separated by a user). In some embodiments, the housing 410 includes a coupling structure configured to removably couple to the extension member 408 of the dentition coupling device 402. In this manner, the dentition coupling device 402 can be a disposable component that may be custom fabricated for each patient, while the light source assembly 404 may be reused with multiple dentition coupling devices. In some embodiments, the housing 410 includes a connector that is configured to mate with a connector on the dentition coupling device 402. Additionally or alternatively, the housing 410 may couple to the dentition coupling device 402 with a magnetic clasp. Some embodiments include a registration structure that is configured to cause the housing 410 to join with the dentition coupling device 402 in a repeatable arrangement and orientation. In some embodiments, the registration structure comprises a plurality of pins and corresponding receivers. In an example, the registration structure includes a plurality of pins disposed on the housing 410 and corresponding receivers (e.g., holes) in the dentition coupling device 402 (or vice versa). In some embodiments, the registration structure comprises a plurality of spherical attachments and a plurality of grooves. In one example, the registration structure includes three or more spherical attachments disposed on the housing 410 and two or more v-shaped grooves disposed on the dentition coupling device 402 that are disposed such that the spherical attachments will only fit into the grooves when the housing 410 is in a specific orientation and position relative to the dentition coupling device 402. In some implementations, the registration structure includes a spring-mounted pin or screw that serves as a detent to impede movement of the housing 410 with respect to the dentition coupling device 402.

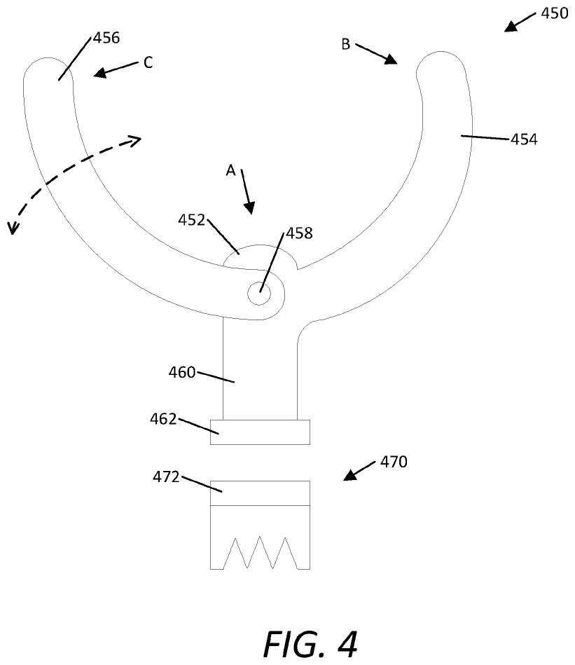

FIG. 4 is a top view of a schematic diagram of an embodiment of a dentition coupling device 450. The dentition coupling device 450 is an example of the dentition coupling device 124 or the dentition coupling device 130. Also shown is a portion of an embodiment of a position indicator system 470. The position indicator system 470 is an example of the position indicator system 134 or the position indicator system 128.

The dentition coupling device 450 includes a base region 452, a fixed arm 454, a pivot arm 456, a pivot joint 458, an extension member 460, and an attachment assembly 462. In this example, the dentition coupling device 450 may mechanically couple to the patient's dentition by making contact with patient's dentition at three or more contact areas. The contact areas may be point contacts or larger regions of contact.

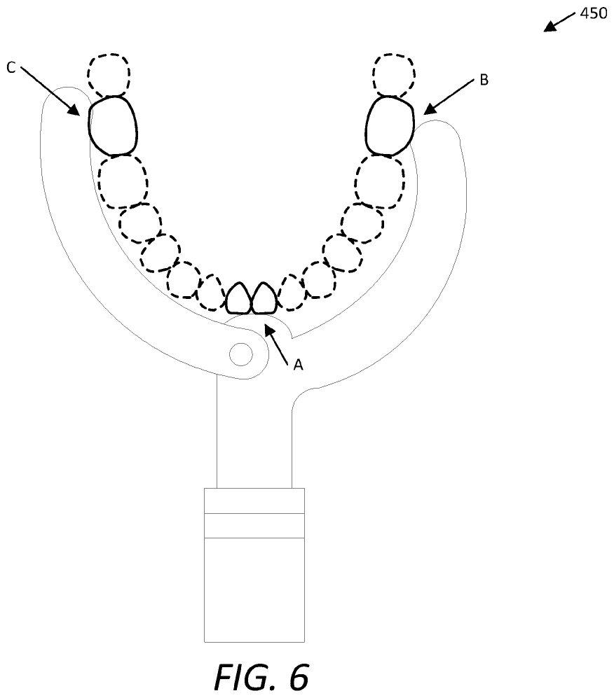

For example, the dentition coupling device 450 may make contact at the contact areas labeled A, B, and C. The contact areas A is on the edge of the base region 452, the contact area B is on the edge of the fixed arm 454, and the contact area C is on the edge of the pivot arm 456. To secure the dentition coupling device 450 to the patient's dentition, the base region 452 may be positioned so that the contact area A touches the labial surface of one or more of the patient's incisors; the dentition coupling device 450 may then be rotated so that the contact area B touches the buccal surface of the patient's posterior teeth on one side; and the pivot arm 456 may be rotated with respect to the base region 452 so that the contact area C touches the buccal surface of the patient's posterior teeth on the opposite side. FIG. 6 shows an example of the dentition coupling device 450 in contact with a patient's dentition.

The base region 452 may be a rigid structure formed from a thin sheet of rigid material such as metal, plastic, or a composite material. In some implementations, the base region 452 is formed integrally with the fixed arm 454 and the extension member 460. The base region 452 may be fixedly joined to the fixed arm 454 and the extension member 460 such that during typical use of the dentition coupling device 450 the relationship between the base region 452 and the fixed arm 454 and the extension member 460 does not change.

The pivot arm 456 is joined to the base region 452 at the pivot joint 458. The pivot joint 458 allows the pivot arm 456 to rotate with respect to the base region 452. In some implementations, the pivot joint 458 includes a rivet. For example, a rivet may be used when the contact areas are bonded to the patient's dentition. The pivot joint 458 may also include a bolt that can be adjusted to control whether the pivot arm 456 rotates with respect to the base region 452.

The edges of the base region 452, fixed arm 454, and pivot arm 456 may include various structures adapted to contact the patient's dentition. For example, the edges may include contoured regions shaped to fit the embrasures of the patient's dentition. The edges may also include concave regions or bonding surfaces that are adapted to bond to the patient's dentition with a bonding agent. The bonding surfaces may be formed directly on the edges or may be disposed on removable blocks that are configured to join to the edges. The removable blocks may be disposable or reusable. The blocks may be formed from various materials, such as plastic materials. For example, the blocks may be formed from Delrin® acetal homopolymer.

The extension member 460 is a rigid elongate member that is configured to protrude out through the patient's mouth when the dentition coupling device 450 is coupled to a patient's dentition. One end of the extension member 460 is joined to the base region 452. The other end of the extension member 460 is joined to the position indicator system 470. Here, the extension member 460 includes an attachment assembly 462 for removably joining to a corresponding attachment assembly 472 of the position indicator system 470.

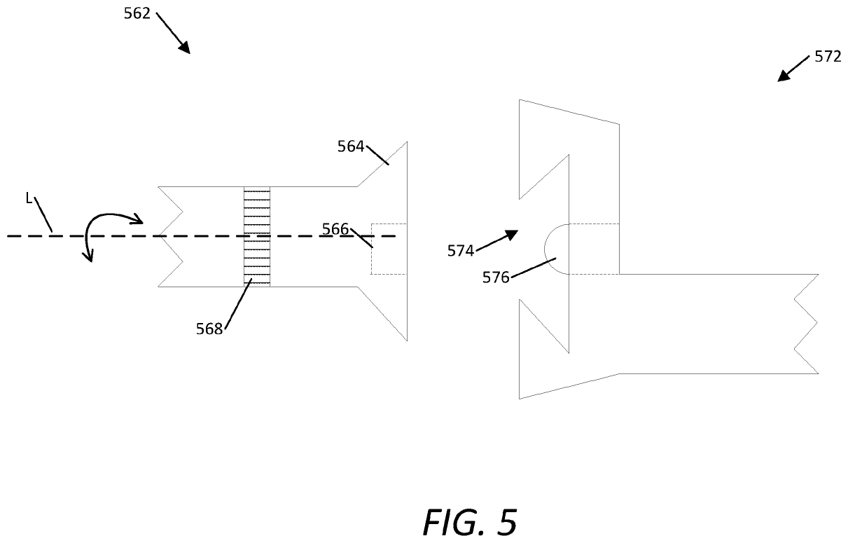

FIG. 5 is a schematic diagram of an embodiment of an attachment assembly 562 and an embodiment of a corresponding attachment assembly 572. The attachment assembly 562 is an example of the attachment assembly 462 and may be a component of a dentition coupling device. The attachment assembly 572 is an example of the attachment assembly 472 and may be a component of a position indicator system 470.

Here, the attachment assembly 562 includes a keyed structure 564 that is sized and shaped to slide into a corresponding keyed slot 574 of the attachment assembly 572. The keyed structure 564 may allow the attachment assembly 562 to slide in the keyed slot 574 in a specific orientation. Here, the keyed structure 564 and the keyed slot 574 have a dove-tailed structure. Other embodiments may have keyed structures with different shapes that fit a corresponding keyed slot.

In this example, the attachment assembly 572 includes a detent 576. The detent 576 may be a spring-loaded pin that will extend out when a corresponding indent 566 in the attachment assembly 562 is aligned with the detent 576. In this manner, the detent 576 may impede further sliding motion of the attachment assembly 562 with respect to the attachment assembly 572.

In this example, the attachment assembly 562 also includes a pivot assembly 568. The pivot assembly 568 may allow the attachment assembly 562 to rotatably pivot about the long axis L of the attachment assembly 562. For example, a caregiver may use the pivot assembly 568 to rotate the attachment assembly 562 so that the attachment assembly 572 and the position indicator system to which it is connected is level with respect to the horizontal plane or the patient's occlusal plane after the dentition coupling device has been attached.

FIG. 7 is a top view of a schematic diagram of an embodiment of a dentition coupling device 590. The dentition coupling device 590 is an example of the dentition coupling device 124 or the dentition coupling device 130. Also shown is a portion of the position indicator system 470. The dentition coupling device 590 may, for example, be used with a patient who is partially or fully edentulous.

The dentition coupling device 590 is similar to the dentition coupling device 450 except that the fixed arm 454 includes a slot 592 and the pivot arm 456 includes a slot 594. The slots 592 and 594 are sized to receive one or more fasteners. In this example, a fastener 596A is shown being inserted in the slot 594 and fasteners 596B and 596C are shown being inserted in the slot 592. Various embodiments of the fasteners 596A, 596B, and 596C are possible. For example, the fasteners 596A, 596B, and 596C may be temporary anchorage devices (TADs) that are configured to penetrate the patient's gingival tissue. The fasteners 596A, 596B, and 596C may also be implant screws that are configured to mate with a receiver of a dental implant that has been surgically implanted in the patient's bone tissue.

In this example, the dentition coupling device is coupled to the patient's dentition using the fasteners 596A, 596B, and 596C. The fasteners may be positioned appropriately within the slots 592 and 594 and then screwed into the patient's dentition (or dental implant receivers). For example, the fixed arm 454 may be aligned over one side of the patient's gum tissue and the pivot arm 456 may be rotated so as to align over the other side of the patient's gum tissue.

In some implementations, the dentition coupling device includes one or more bases configured to fit over edentulous regions of the patient's dentition. For example, some implementations may include a maxillary base and a mandibular base. Similar to a gothic arch tracer, the maxillary base and a mandibular base may be joined by an adjustable height structure. The adjustable height structure may include a centrally located pin/rod (rigid structure) or multiple pin/rods arranged along the dental arch. The adjustable height structure may be adjusted to determine an appropriate vertical dimension for the patient. The bases may be held in place, at least in part, by suction or the patient's biting force. The bases may include an attachment assembly for attaching a position indicator system.

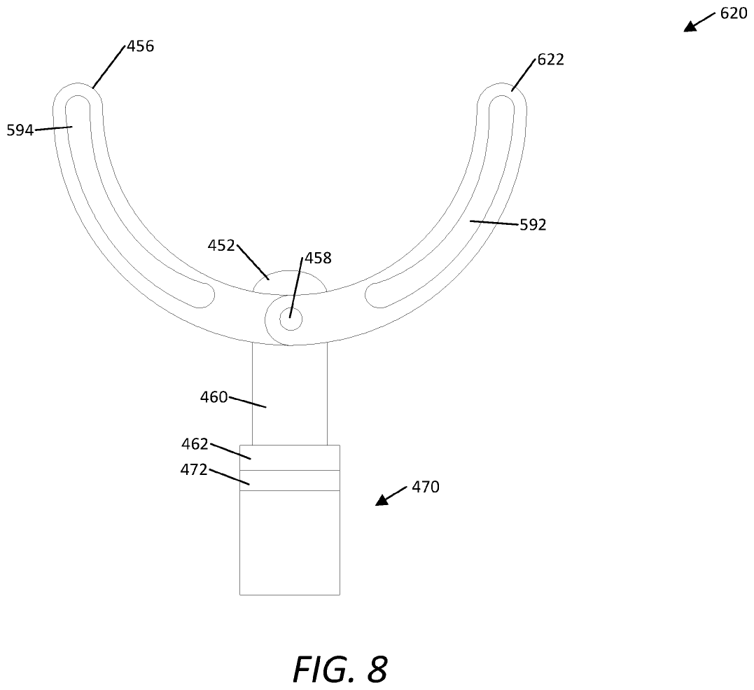

FIG. 8 is a top view of a schematic diagram of an embodiment of a dentition coupling device 620. The dentition coupling device 620 is an example of the dentition coupling device 124 or the dentition coupling device 130. Also shown is a portion of the position indicator system 470. The dentition coupling device 620 is similar to the dentition coupling device 590 except that the fixed arm 454 of the dentition coupling device 590 has been replaced by a second pivot arm 622. In this example, both the pivot arm 456 and the pivot arm 622 may pivot to align with the patient's dentition. Although the dentition coupling device 620 includes the slots 592 and 594, embodiments are possible that do not include the slots 592 and 594 and are instead configured to contact the buccal/labial surfaces of the patient's dentition (e.g., as described with respect to at least FIG. 4).

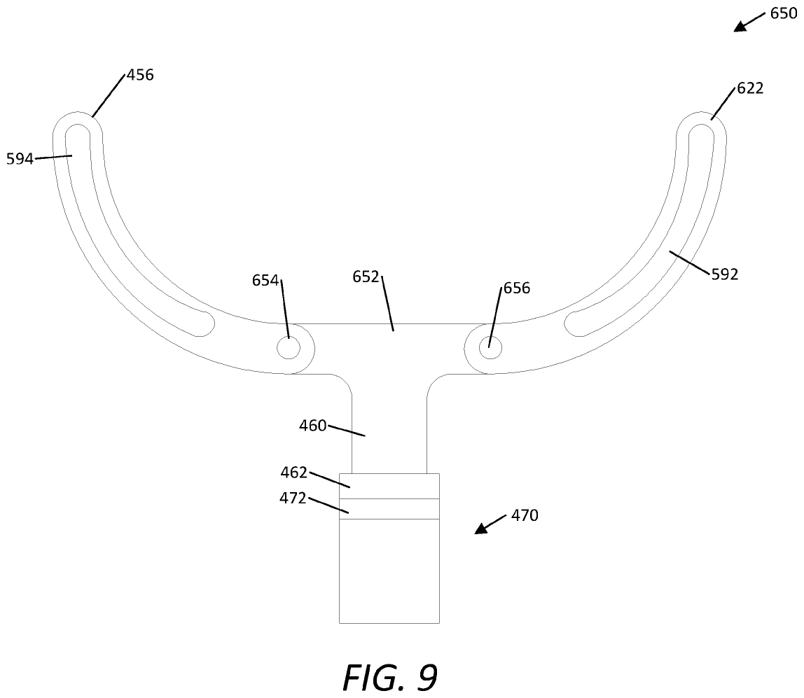

FIG. 9 is a top view of a schematic diagram of an embodiment of a dentition coupling device 650. The dentition coupling device 650 is an example of the dentition coupling device 124 or the dentition coupling device 130. Also shown is a portion of the position indicator system 470. The dentition coupling device 650 is similar to the dentition coupling device 620 except that the base region 452 has been replaced by a t-shaped base 652 that includes a pivot joint 654 and a pivot joint 656. The pivot joint 654 rotatably joins the pivot arm 456 to the t-shaped base 652, and the pivot joint 656 rotatably joins the pivot arm 622 to the t-shaped base 652. The two separate pivot joints 654 and 656 may allow the pivot arms 456 and 622 to be on the same horizontal plane (i.e., not offset vertically from one another).

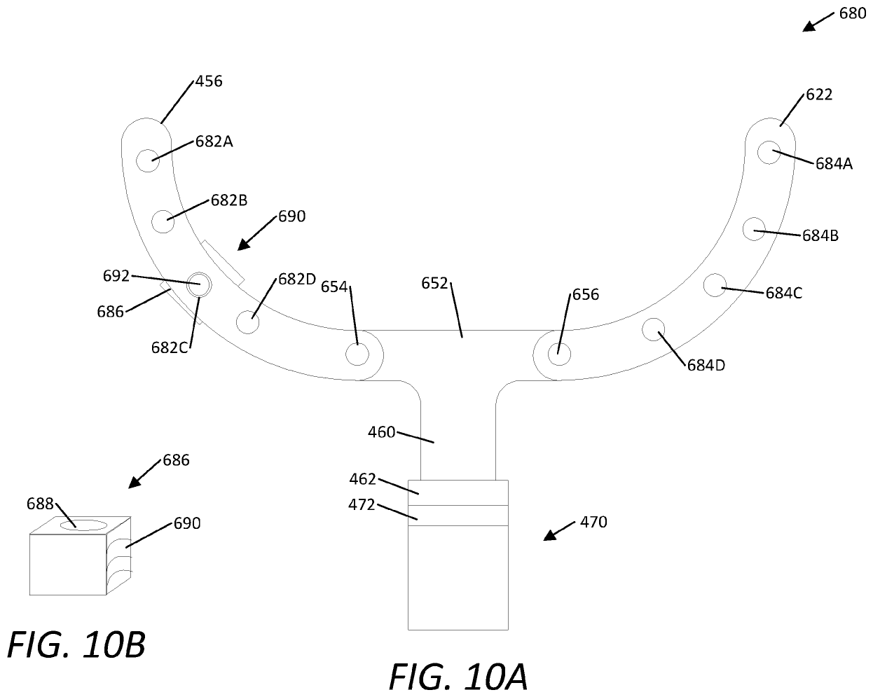

FIG. 10A is a top view of a schematic diagram of an embodiment of a dentition coupling device 680. The dentition coupling device 680 is an example of the dentition coupling device 124 or the dentition coupling device 130. Also shown is a portion of the position indicator system 470. The dentition coupling device 680 is similar to the dentition coupling device 680 except that the slot 592 of the pivot arm 622 has been replaced with apertures 684A, 684B, 684C, and 684D (referred to collectively as apertures 684); and the slot 594 of the pivot arm 456 has been replaced with apertures 682A, 682B, 682C, and 682D (referred to collectively as apertures 682).

In some implementations, the apertures 682 and 684 allow fasteners to pass through to secure the dentition coupling device 680 to the gingival tissue of the patient or to dental implants disposed within the gingival tissue of the patient. In this example, a bonding block 686 is shown. Here, the bonding block 686 is disposed below the dentition coupling device 680 (i.e., towards the gingival direction) so as to minimize the interference with a dentition coupling device attached to the patient's opposing dentition.

FIG. 10B is a schematic diagram of the bonding block 686. The bonding block 686 may be attached to the dentition coupling device with a fastener 692, such as a screw or bolt, that passes through a slot 688 of the bonding block 686 and an aperture of the dentition coupling device. In FIG. 10A, the fastener 692 passes through the slot 688 of the bonding block 686 and through the aperture 682C of the pivot arm 456. The slot 688 may allow the bonding block 686 to move in towards or out away from the patient's dentition. The slot 688 may also allow for rotation of the bonding block 686 to improve the alignment of a bonding surface 690 of the bonding block 686 to the patient's dentition. The bonding surface 690 may have various shapes or features to improves its fit against the patient's dentition. In some implementations, the bonding surface 690 is flat. In some implementations, the boding surface 690 is concave. In some implementations, the boding surface 690 may have one or more ridges or protrusions that are sized to fit in the embrasures of a patient's dentition. The bonding surface 690 may have a rough surface to increase friction with the patient's dentition or adhesion with a bonding agent. The bonding block 686 may be formed from various materials, including plastics, polymers, and composite materials.

In some implementations, multiple bonding blocks are used to secure the dentition coupling device 680 to the patient's dentition. For example, three bonding blocks are used in some implementations, with at least one bonding block being placed on each of the pivot arms toward the posterior and one bonding block in the anterior region.

In some implementations, the apertures 682 or the apertures 684 are used to attach structures other then bonding blocks to the pivot arms. For examples, some implementations may include a deprogramming device such as a Lucia jig, leaf gauge, or bite plane, that prevents occlusal contact between the patient's posterior teeth. By preventing interference between the posterior teeth, the deprogramming device may allow the patient's jaw to move into a more relaxed position. In some implementations, a deprogramming device is a device that attached to the dentition coupling device and prevents teeth from coming into contact. Similarly, the deprogramming device may be attached to the slots discussed with respect to other implementations, such as the slots 592 and 594.

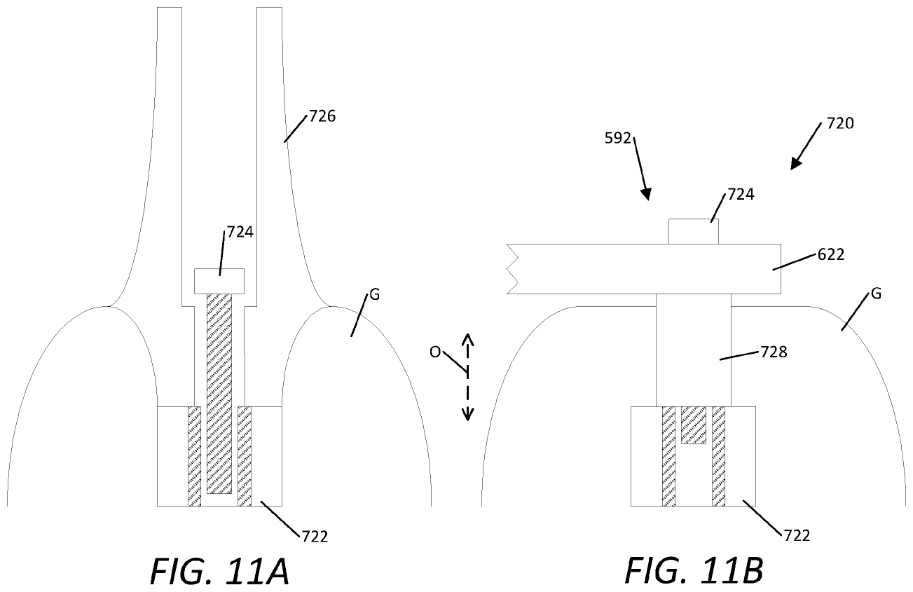

FIGS. 11A-B are cross-sectional side views that illustrate the attachment of an embodiment of a dentition coupling device 720 to a dental implant 722. The dentition coupling device 720 is an example of the dentition coupling device 124 or the dentition coupling device 130. The dentition coupling device 720 may be similar to the dentition coupling device 650.

FIG. 11A is a cross-sectional side view that illustrates an implant abutment 726 attached to a dental implant 722 that is disposed in the patient's gingival tissue G. The implant abutment 726 is held in place with an implant screw 724. The implant screw 724 has threads that mate with corresponding threads in a receiver of the dental implant 722.

FIG. 11B is a cross-sectional side view of the dental implant 722 and gingival tissue G with the implant abutment 726 removed and the dentition coupling device 720 attached to the dental implant 722. Here, the implant screw 724 passes through the slot 592 of the pivot arm 622 of the dentition coupling device 720, through an offset 728, and into the dental implant 722. As shown in this figure, at least a portion of the threads of the implant screw 724 are interlocked with the threads of the receiver of the dental implant 722. The offset 728 may be a cylindrical structure that includes an aperture through which a portion of the implant screw 724 may pass. For example, an aperture in the offset 728 may allow passage of the threaded portion of the implant screw 724 but not the head of the implant screw 724. The offset 728 may be sized in the occlusal dimension (0) so as to offset the pivot arm 622 from the gingival tissue G.

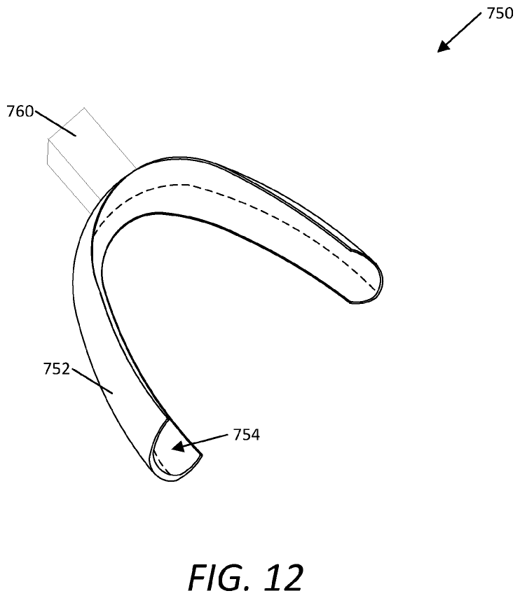

FIG. 12 is a schematic diagram of an embodiment of a dentition coupling device 750. The dentition coupling device 750 is an example of the dentition coupling device 124 or the dentition coupling device 130.

The dentition coupling device 750 includes a shell 752 that is shaped to form a channel 754. Although alternatives are possible, the shell 752 may be a thin shell having a rounded shape.

The dentition coupling device 750 may also include an extension member 760. The extension member 760 may be similar to the extension member 460 and is configured to protrude out through the patient's mouth when the dentition coupling device 750 is coupled to a patient's dentition. Although not shown, the extension member may include an attachment assembly for attaching a position indicator system.

To attach the dentition coupling device 750 to a patient, the channel 754 may be filled with an impression material. The dentition coupling device 750 may then be positioned adjacent to the patient's dentition while the impression material bonds to the shell 752 and hardens to the shape of the patient's teeth. The impression material may snugly grip the patient's dentition, filling in the embrasures and interproximal regions to mechanical couple to the patient's dentition. In some implementations, the shell 752 may include various features such as holes, grooves, indents, or ridges that may allow the impression material to form a more secure bond with the shell 752.

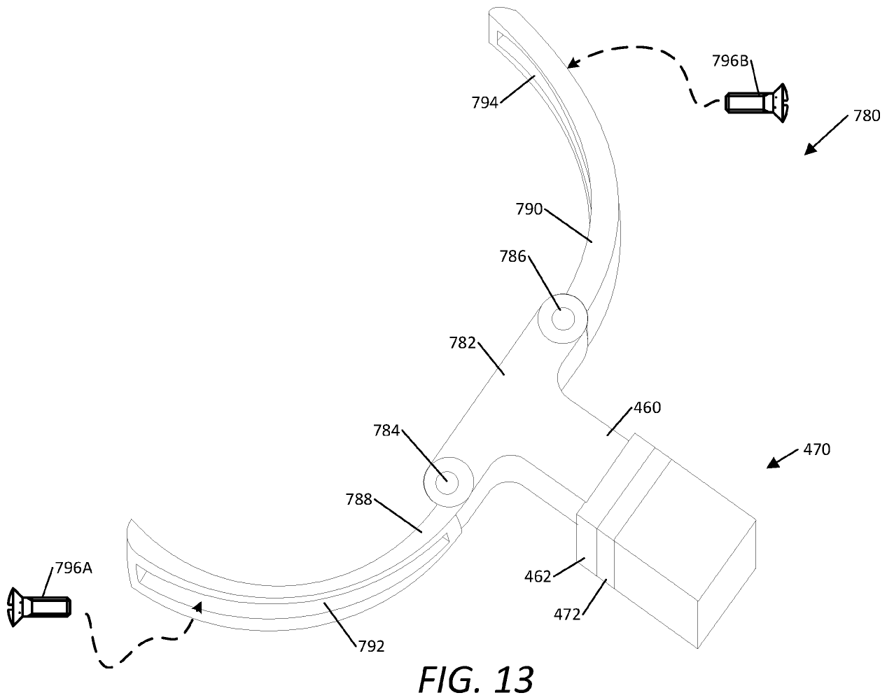

FIG. 13 is a schematic diagram of an embodiment of a dentition coupling device 780. The dentition coupling device 780 is an example of the dentition coupling device 124 or the dentition coupling device 130. Also shown is a portion of the position indicator system 470.

The dentition coupling device 780 is similar to the dentition coupling device 650 except that the pivot arms have slots that are oriented for passage of a fastener in a horizontal orientation (or buccal-labial dimension) rather than a vertical orientation (or occlusal-gingival dimension). The dentition coupling device 780 includes a t-shaped base 782 that has a pivot joint 784 and a pivot joint 786. The pivot joint 784 rotatably joins the pivot arm 788 to the t-shaped base 782, and the pivot joint 786 rotatably joins the pivot arm 790 to the T-shaped base 782. The pivot arm 788 includes a slot 792 on a horizontal surface of the pivot arm 788. Similarly, the pivot arm 790 includes a slot 794 on a horizontal surface of the pivot arm 790. The slots 792 and 794 may allow passage of one or more fasteners, such as the fasteners 796A and 796B, through the pivot arms 788 and 790 to make contact with the buccal/labial surfaces of the patient's teeth or with the patient's gum tissue. The fasteners 796A and 796B may be configured to penetrate the patient's gum tissue to secure the dentition coupling device 780. The fasteners 796A and 796B may be configured to fit into an embrasure on interproximal region of a patient's teeth to secure the dentition coupling device 780.

The pivot joint 654 rotatably joins the pivot arm 456 to the t-shaped base 652, and the pivot joint 656 rotatably joins the pivot arm 622 to the t-shaped base 652. The two separate pivot joints 654 and 656 may allow the pivot arms 456 and 622 to be on the same horizontal plane (i.e., not offset vertically from one another).

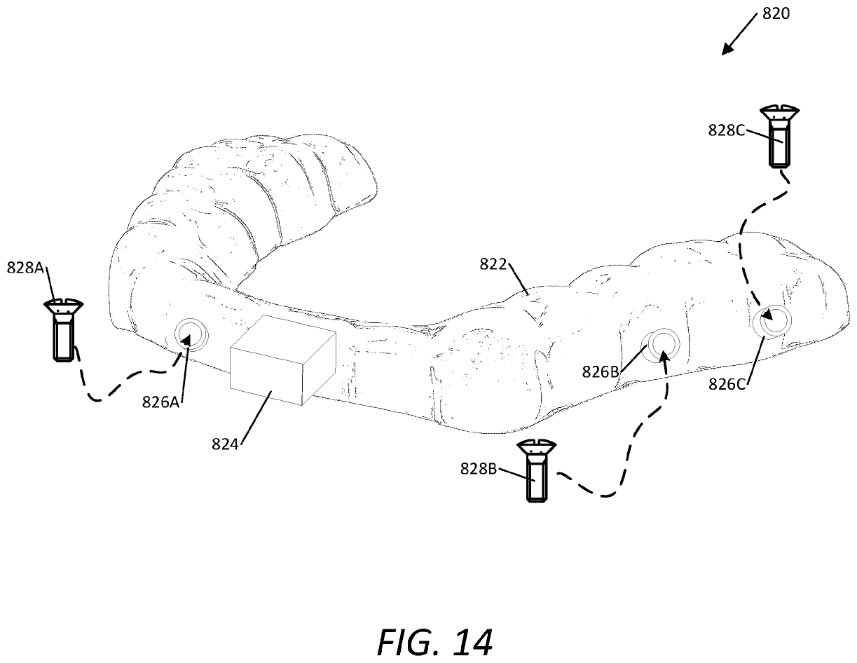

FIG. 14 is a schematic diagram of an embodiment of a dentition coupling device 820. The dentition coupling device 820 is an example of the dentition coupling device 124 or the dentition coupling device 130.

The dentition coupling device 820 includes a shell 822 and an extension member 824. The shell 822 may be a thin shell formed from a thermoplastic material, similar to an orthodontic aligner. The shell 822 may provide a snug mechanical fit to the contours of the patient's dentition. Some implementations also include apertures 826A, 826B, and 826C that permit fasteners 828A, 828B, and 828C to pass through and contact the patient's gum tissue or dentition to further secure the dentition coupling device 820. In some implementations, the apertures 826A, 826B, and 826C are surrounded by a reinforced region that may be thicker than other parts of the shell 822.

The extension member 824 may be similar to the previously described extension member 460. In some implementations, the extension member 824 is formed integrally with the shell 822. In some implementations, the extension member 824 may be a separate component that is joined to the shell 822 with a mechanical fastener or adhesive.

The shell 822 may be formed specifically for the patient. For example, the shell 822 may be automatically or manually designed with a computer aided drafting (CAD) program based on a digital impression of a patient. The shell may then be fabricated using a rapid manufacturing technology such as 3D printing or computer-aided milling technology.

The shell 822 may also be formed from a thermoplastic material that softens when heated. The shell 822 may have a standard shape but then be modified to fit the specific patient by, for example, heating the shell 822 in boiling water and then having the patient bite into the heated shell 822. As the shell cools, it may harden into a shape that fits the patient's dentition.

The shell 822 may be held in place on the patient's dentition by a combination of a snug retentive force from the shape of the shell 822 and the fasteners 828A, 828B, and 828C. Some embodiments include more, fewer, or no fasteners. In some embodiments, the shell 822 may be further secured to the patient's dentition using a bonding agent. For example, the shell 822 may be designed with an offset from the patient's dentition (in at least some regions) to allow space for the bonding agent.

In some embodiments, the shell 822 does not cover some or all of the occlusal surface of the patient's dentition. For example, the thin shell 822 may cover a portion fo the buccal surface of the patient's dentition. For example, the shell 822 may extend up from the gingival margin or around the gingival margin (e.g., 0.5-3 mm up in the occlusal direction above the gingival margin) to the height of contour or near the height of contour on the patient's dentition. The height of contour may refer to the position in the occlusal-gingival dimension on the patient's dentition that is furthest out in the buccal/labial direction. The height of contour may, for example, occur between 50-80% of the way up from the gingival margin to the occlusal surface of a tooth. In some implementations, the shell 822 will stop slightly under (e.g., toward the gingival) the height of contour. In these implementations, the shell 822 may fit the patient's dentition in a repeatable manner as it will be too narrow to fit over the height of contour.

In some implementations, the shell 822 will cover the occlusal surfaces of some teeth and not the occlusal surfaces of other teeth. For example, the shell 822 may cover the occlusal surfaces of the patient's posterior teeth, but not the patient's anterior teeth. In some implementations, the shell 822, may cover the occlusal surfaces of the patient's anterior teeth, but not the patient's posterior teeth. In some implementations, the shell may cover the occlusal surfaces of all of the patient's teeth except the cuspids.

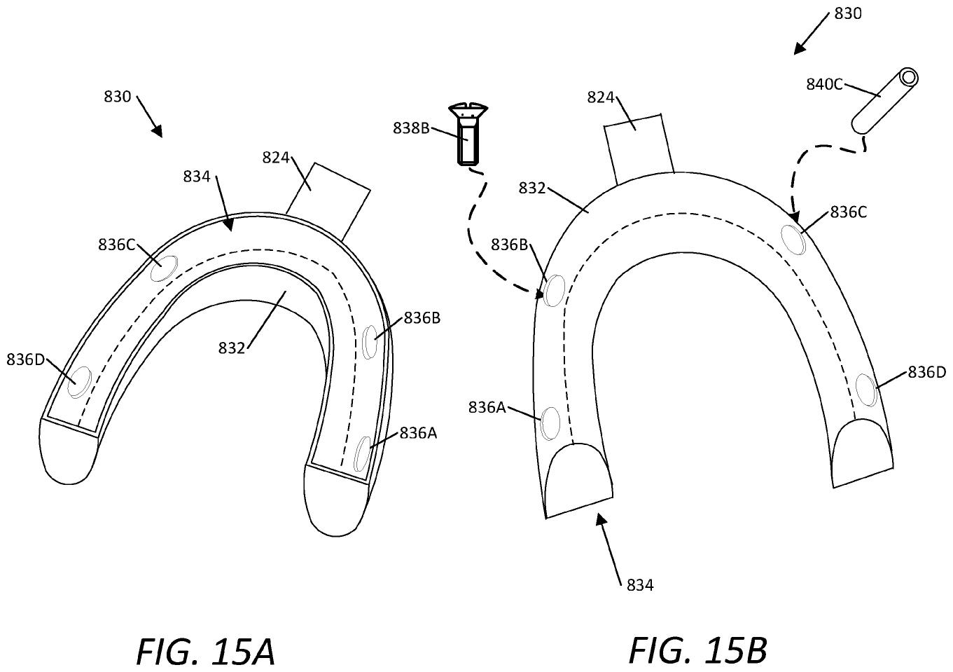

FIGS. 15A-B are schematic diagrams of an embodiment of a dentition coupling device 830. The dentition coupling device 830 is an example of the dentition coupling device 124 or the dentition coupling device 130. FIG. 15A shows a view of the side of the dentition coupling device 830 that would face the patient's teeth when worn, and FIG. 15B shows a view of the opposite side of the dentition coupling device 830.

The dentition coupling device 830 includes an impression tray 832 and an extension member 824. The impression tray 832 may be formed from any rigid material, such as metal or some plastic or composite materials, and may form a trough 834 in which impression material may be placed. For example, the impression tray 832 may be placed on a patient's dentition and the trough 834 may be filled with warm impression material. The impression material may then be allowed to cool and harden, forming into a solid structure that fits the contours of the patient's dentition.

In this example, the impression tray 832 includes apertures 836A, 836B, 836C, and 836D (referred to collectively as apertures 836) that permit one or more fasteners, such as fastener 838B, to pass through and contact the patient's gum tissue or dentition to further secure the dentition coupling device 830. More fasteners may be used, but are not shown in these figures.

In some implementations, after the impression material has hardened, the impression tray and impression material are temporarily removed from the patient's dentition. The hardened impression material may then be cleared from the apertures 836. For example, a hand drill may be used to clear impression material in the apertures 836, opening up pathways for fasteners to pass through to and contact the patient's gum tissue or dentition when the dentition coupling device 830 is placed back on the patient's dentition.

The dentition coupling device 830 may then be secured to the patient's dentition with the fasteners. The fasteners may, for example, be temporary anchorage devices, screws, pins, or any other type of structure that can pass through the apertures in the dentition coupling device 830 and secure the dentition coupling device 830 to the patient's gum tissue, underlying bone tissue, or dentition. The position of the dentition coupling device 830 with respect to the patient's dentition may be fixed by the hardened impression material, which will only fit the patient's dentition in a specific orientation.

In some implementations, one or more sleeves, such as sleeve 840C, may be inserted in the apertures 836 to block at least some of the impression material from reaching the apertures 836 and hardening between the apertures 836 and the patient's dentition. The sleeves may be cylindrical in shape and sized to fit snugly through the apertures 836. The sleeves may be solid or hollow. The sleeves may be inserted through the apertures 836 after the impression tray 832 is placed over the patient's dentition either before impression material is added or before the impression material has hardened. The sleeves may then be pushed through the apertures 836 until making contact with the patient's dentition. After the impression material has hardened, the sleeves can be removed, leaving an opening that may need little to no clearing of impression material.

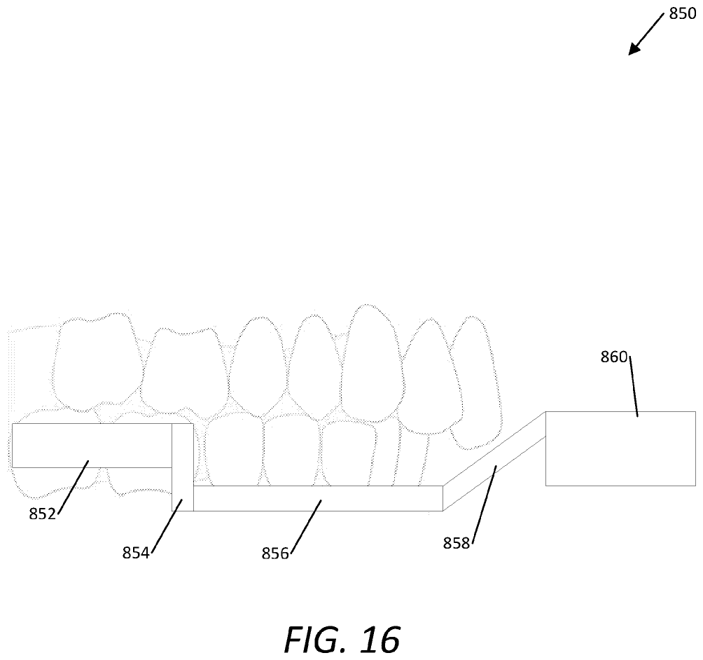

FIG. 16 is a schematic diagram of a profile view of an embodiment of a dentition coupling device 850. The dentition coupling device 850 is an example of the dentition coupling device 124 or the dentition coupling device 130. As the dentition coupling device 850 is shown in profile, only one side is visible. It should be understood that the same components may be present on the opposite side of the patient's dentition. Together, the two sides of the dentition coupling device 850 may work together to securely attach the dentition coupling device 850 the patient's dentition.

In this example, the dentition coupling device 850 may be used with a patient who has an excessive overbite (e.g., the anterior upper teeth extend significantly over 30-50% or more of the lower anterior teeth). With these patient's, the upper anterior teeth may interfere with an extension member that protrudes straight out from the buccal surface of the patient's lower anterior teeth.

In this example, the dentition coupling device includes an attachment portion 852, a gingival offset 854, an anterior offset 856, an occlusal offset 858, and an extension member 860. The extension member 860 is configured to protrude out through the patient's mouth and may be similar the previously described extension members, such as the extension member 824.

The attachment portion 852 may be configured to couple to the patient's dentition. For example, the attachment portion 852 may include any of the previously discussed structures for coupling to a patient's dentition, such as slots or aperture that may receiving bonding blocks to couple to the patient's teeth, apertures for receiving fasteners to couple to the patient's dentition, shells with contours to fit a portion of the patient's dentition, etc.

The gingival offset 854 is a rigid structure that serves to connect the attachment portion 852 to the anterior offset 856. The gingival offset 854 may offset the anterior offset 856 in the gingival direction with respect to the attachment portion 852 by any amount. In some implementations, the gingival offset 854 may offset the anterior offset 856 by between 1 and 15 mm. Although the gingival offset 854 is shown as being oriented in a direction that is parallel to the gingival-occlusal dimension, other embodiments are possible too. For example, the gingival offset 854 may oriented at a diagonal such that it joins with the anterior offset 856 at a position that is both gingival and anterior to the position it joins with the attachment portion. As can be seen, the gingival offset 858 may position the anterior offset 856 gingivally so that the anterior offset 856 does not interfere with the patient's upper teeth.

The anterior offset 856 is a rigid structure that serves to connect the gingival offset 854 to the occlusal offset 858. In some implementations, the anterior offset 856 extends in the anterior direction from the position at which it joins the gingival offset to a position that is near or past the buccal surfaces of the patient's anterior teeth. The anterior offset may extend along a line that is below (i.e., towards the gingival of the patient's lower teeth) the occlusal surfaces (or incisal edges) of the patient's upper anterior teeth.

In some implementations, the anterior offset 856 includes contours that are designed to follow the dentition of the patient. In some implementations, the anterior offset 856 may include apertures throughwhich fasteners may be inserted to secure the anterior offset to the patient's dentition. In some implementations, the anterior offset 856 may not include features to secure to the patient's dentition.

The occlusal offset 858 is a rigid structure that connects the anterior offset 856 to the extension member 860. In some implementations, an end of the occlusal offset 858 that joins to the anterior offset 856 is disposed at a position that is gingival with respect to an end of the anterior offset 856 that is joined to the extension member 860. As shown in FIG. 16, the occlusal offset 858 may be oriented at a diagonal such that the end that joins to the anterior offset is disposed at a position that is both occlusal and gingival to the end that joins to the extension member 860. In some embodiments, the occlusal offset 858 may be oriented parallel to the occlusal-gingival dimension. As can be seen, the occlusal offset 858 may position the extension member 860 occlusally so that the extension member 860 can protrude through the patient's lips without pulling the patient's lips down.

Although the attachment portion 852, gingival offset 854, anterior offset 856, and occlusal offset 858 are shown as separate components in this example, in some implementations some or all of these components may be a single, integral component. For example, the gingival offset 854, anterior offset 856, and occlusal offset 858 may be formed from a single arc shaped component.

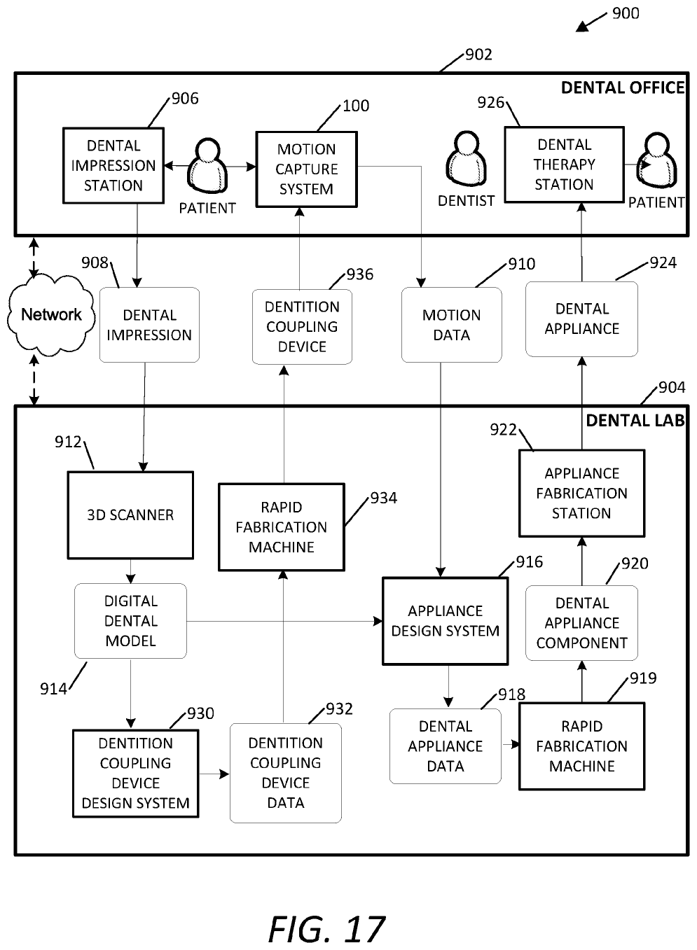

FIG. 17 is a schematic block diagram illustrating an example of a system 900 for using jaw motion captured by the motion capture system 100 to fabricate a dental appliance 924 or provide dental therapy. In this example, the system 900 includes a dental office 902 and a dental lab 904.

The example dental office 902 includes a dental impression station 906, the motion capture system 100, and a dental therapy station 926. Although shown as a single dental office in this figure, in some embodiments, the dental office 902 includes multiple dental offices. For example, in some embodiments, one or both of the dental impression station 906 and the motion capture system 100 are in a different dental office than the dental therapy station 926. Further, in some embodiments, one or more of the dental impression station 906, the motion capture system 100, and the dental therapy station 926 are not in a dental office.

The example dental impression station 906 generates a dental impression 908 of the dentition of the patient. The dental impression 908 is a geometric representation of the dentition of the patient. In some embodiments, the dental impression 908 is a physical impression captured using an impression material, such as sodium alginate, or polyvinylsiloxane. In other embodiments, other impression materials are used. In some embodiments, the dental impression is captured by an impression device.

In some embodiments, the dental impression 908 is a digital impression. The digital impression may be represented by one or more of a point cloud, a polygonal mesh, a parametric model, or voxel data. In some embodiments, the digital impression is generated directly from the dentition of the patient, using for example an intraoral scanner. Example intraoral scanners include the TRIOS Intra Oral Digital Scanner, the Lava Chairside Oral Scanner C.O.S., the Cadent iTero, the Cerec AC, the Cyrtina IntraOral Scanner, and the Lythos Digital Impression System from Ormco. In other embodiments, a digital impression is captured using other imaging technologies, such as computed tomography (CT), including cone beam computed tomography (CBCT), ultrasound, and magnetic resonance imaging (MRI). In yet other embodiments, the digital impression is generated from a physical impression by scanning the impression or plaster model of the dentition of the patient created from the physical impression. Examples of technologies for scanning a physical impression or model include three-dimensional laser scanners and computed tomography (CT) scanners. In yet other embodiments, digital impressions are created using other technologies.

The motion capture system 100 has been described previously and captures a representation of the movement of the dental arches relative to each other. In some embodiments, the motion capture station generates motion data 910.

In other embodiments, the motion capture system 100 generates motion data 910 representing the movement of the arches relative to one another. As will be described further below, the motion capture system 100 may include a dentition coupling device 936 that is generated for a specific patient based on the dental impression 908.

In some embodiments, the motion capture system 100 generates the motion data 910 from optical measurements of the dental arches that are captured while the dentition of the patient is moved. In some embodiments, the optical measurements are extracted from image or video data recorded while the dentition of the patient is moved. Additionally, in some embodiments, the optical measurements are captured indirectly. For example, in some embodiments, the optical measurements are extracted from images or video data of one or more devices (e.g., the patient assembly 104) that are secured to a portion of the dentition of the patient. In other embodiments, the motion data 910 is generated using other processes. Further, in some embodiments, the motion data 910 includes transformation matrices that represent the position and orientation of the dental arches. The motion data 910 may include a series of transformation matrices that represent various motions or functional paths of movement for the patient's dentition. Other embodiments of the motion data 910 are possible as well.

In some embodiments, still images are captured of the patient's dentition while the dentition of the patient is positioned in a plurality of bite locations. In some embodiments, image processing techniques are used to determine the positions of the patient's upper and lower arches relative to each other (either directly or based on the positions of the attached patient assembly 104). In some embodiments, the motion data 910 is generated by interpolating between the positions of the upper and lower arches determined from at least some of the captured images.

The motion data 910 may be captured with the patient's jaw in various static positions or moving through various motions. For example, the motion data 910 may include a static measurement representing a centric occlusion (i.e., the patient's mandible closed with teeth fully engaged) or centric relation (i.e., the patient's mandible nearly closed, just before any shift occurs that is induced by tooth engagement or contact) bite of a patient. The motion data 910 may also include static measurements or sequences of data corresponding to protrusive (i.e., the patient's mandible being shifted forward while closed), lateral excursive (i.e., the patient's mandible shifted/rotated left and right while closed), hinging (i.e., the patient's mandible opening and closing without lateral movement), chewing (i.e., the patient's mandible chewing naturally to, for example, determine the most commonly used tooth contact points), and border movements (i.e., the patient's mandible is shifted in all directions while closed, for example, to determine the full range of motion) of the patient's jaw. This motion data 910 may be used to determine properties of the patient's temporomandibular joint (TMJ). For example, hinging motion of the motion data 910 may be used to determine the location of the hinge axis of the patient's TMJ.

The example dental lab 904 includes a 3D scanner 912, an appliance design system 916, a rapid fabrication machine 919, an appliance fabrication station 922, a dentition coupling device design system 930, and a rapid fabrication machine 934. Although shown as a single dental lab in this figure, in some embodiments, the dental lab 904 comprises multiple dental labs. For example, in some embodiments, the 3D scanner 912 is in a different dental lab than one or more of the other components shown in the dental lab 904. Further, in some embodiments, one or more of the components shown in the dental lab 904 are not in a dental lab. For example, in some embodiments, one or more of the 3D scanner 912, appliance design system 916, rapid fabrication machine 919, appliance fabrication station 922, dentition coupling device design system 930, and rapid fabrication machine 934 are in the dental office 902. Additionally, some embodiments of the system 900 do not include all of the components shown in the dental lab 904. Although shown as separate components, in some implementations, the rapid fabrication machine 919 and the rapid fabrication machine 934 are the same component. Similarly, the appliance design system 916 and the dentition coupling device design system 930 may be the same system in some implementations.

The example 3D scanner 912 is a device configured to create a three-dimensional digital representation of the dental impression 908. In some embodiments, the 3D scanner 912 generates a point cloud, a polygonal mesh, a parametric model, or voxel data representing the dental impression 908. In some embodiments, the 3D scanner 912 generates a digital dental model 914. In some embodiments, the 3D scanner 912 comprises a laser scanner, a touch probe, or an industrial CT scanner. Yet other embodiments of the 3D scanner 912 are possible as well. Further, some embodiments of the system 900 do not include the 3D scanner 912. For example, in some embodiments of the system 900 where the dental impression station 906 generates a digital dental impression, the 3D scanner 912 is not included.

The appliance design system 916 is a system that is configured to generate the dental appliance data 918. In some embodiments, the dental appliance data 918 is three-dimensional digital data that represents the dental appliance component 920 and is in a format suitable for fabrication using the rapid fabrication machine 919.

In some embodiments, the appliance design system 916 comprises a computing device including user input devices. The appliance design system 916 may include computer-aided-design (CAD) software that generates a graphical display of the dental appliance data 918 and allows an operator to interact with and manipulate the dental appliance data 918. For example, the appliance design system 916 may include digital tools that mimic the tools used by a laboratory technician to physically design a dental appliance. For example, some embodiments include a tool to move the patient's dentition according to the motion data 910 (which may be similar to a physical articulator). Additionally, in some embodiments, the appliance design system 916 includes a server that partially or fully automates the generation of designs of the dental appliance data 918, which may use the motion data 910.

The appliance design system 916 may be usable to design one or more dental appliance and/or dental treatment concurrently. The motion data 910 may be used to evaluate the interaction between the one or more dental appliances and/or dental treatments. This may be particularly beneficial in designing complex appliances and planning complex dental treatments such as implant supported denture systems.

In some embodiments, the rapid fabrication machine 919 comprises one or more three-dimensional printers, such as the ProJet line of printers from 3D Systems, Inc. of Rock Hill, S.C. Another example of the rapid fabrication machine 919 is stereolithography equipment. Yet another example of the rapid fabrication machine 919 is a milling device, such as a computer numerically controlled (CNC) milling device. In some embodiments, the rapid fabrication machine 919 is configured to receive files in the STL format. Other embodiments of the rapid fabrication machine 919 are possible as well.

Additionally, in some embodiments, the rapid fabrication machine 919 is configured to use the dental appliance data 918 to fabricate the dental appliance component 920. In some embodiments, the dental appliance component 920 is a physical component that is configured to be used as part or all of the dental appliance 924. For example, in some embodiments, the dental appliance component 920 is milled from zirconium or another material that is used directly as a dental appliance. In other embodiments, the dental appliance component 920 is a mold formed from wax or another material and is configured to be used indirectly (e.g., through a lost wax casting or ceramic pressing process) to fabricate the dental appliance 924. Further, in some embodiments, the dental appliance component 920 is formed using laser sintering technology.

In some embodiments, the appliance fabrication station 922 operates to fabricate a dental appliance 924 for the patient. In some embodiments, the appliance fabrication station 922 uses the dental appliance component 920 produced by the rapid fabrication machine 919. In some embodiments, the dental appliance 924 is a filling, partial crown, full crown, veneer, bridge, complete denture, partial denture, implant framework, surgical splint, implant guide, or orthotic splint such as a deprogramming splint or a temporomandibular disorder (TMD) splint. For example, the implant frameworks may support complete or partial dentures and may be designed using implant framework design software applications. Other embodiments of the dental appliance 924 are possible as well. In some embodiments, the dental appliance 924 is formed from an acrylic, ceramic, or metallic material. In some embodiments, the dental impression 908 is used in the fabrication of the dental appliance 924. In some embodiments, the dental impression 908 is used to form a plaster model of the dentition of the patient. Additionally, in some embodiments, a model of the dentition of the patient is generated by the rapid fabrication machine 919. In some embodiments, the appliance fabrication station 922 includes equipment and processes to perform some or all of the techniques used in traditional dental laboratories to generate dental appliances. Other embodiments of the appliance fabrication station 922 are possible as well.

In some embodiments, the dental appliance 924 is seated in the mouth of the patient in the dental therapy station 926 by a dentist. In some embodiments, the dentist confirms that the occlusal surface of the dental appliance 924 is properly defined by instructing the patient to engage in various bites. Additionally, in some embodiments, the dentist D uses the dental appliance 924 to provide a dental therapy such as orthognathic surgery or placement of one or more dental implants.

The dentition coupling device design system 930 may be similar to the appliance design system 916. In some implementations, the dentition coupling device design system 930 is configured to generate dentition coupling device data 932 that corresponds to the previously described implementations of the dentition coupling device 124 or dentition coupling device 130. For example, the dentition coupling device data 932 may represent some or all of a shell for a dentition coupling device, such as the dentition coupling device 820.

The rapid fabrication machine 934 may be similar to the previously described rapid fabrication machine 919. The rapid fabrication machine 934 may fabricate the dentition coupling device 936 based on the dentition coupling device data 932. In some implementations, the rapid fabrication machine 934 may fabricate the dentition coupling device 936 using a biocompatible material that is suitable for being placed directly in a patient's mouth.

Additionally, in some embodiments, the dental office 902 is connected to the dental lab 904 via a network. In some embodiments, the network is an electronic communication network that facilitates communication between the dental office 902 and the dental lab 904. An electronic communication network is a set of computing devices and links between the computing devices. The computing devices in the network use the links to enable communication among the computing devices in the network. The network can include routers, switches, mobile access points, bridges, hubs, intrusion detection devices, storage devices, standalone server devices, blade server devices, sensors, desktop computers, firewall devices, laptop computers, handheld computers, mobile telephones, and other types of computing devices.

In various embodiments, the network includes various types of links. For example, the network can include one or both of wired and wireless links, including Bluetooth, ultra-wideband (UWB), 802.11, ZigBee, and other types of wireless links. Furthermore, in various embodiments, the network is implemented at various scales. For example, the network can be implemented as one or more local area networks (LANs), metropolitan area networks, subnets, wide area networks (such as the Internet), or can be implemented at another scale.

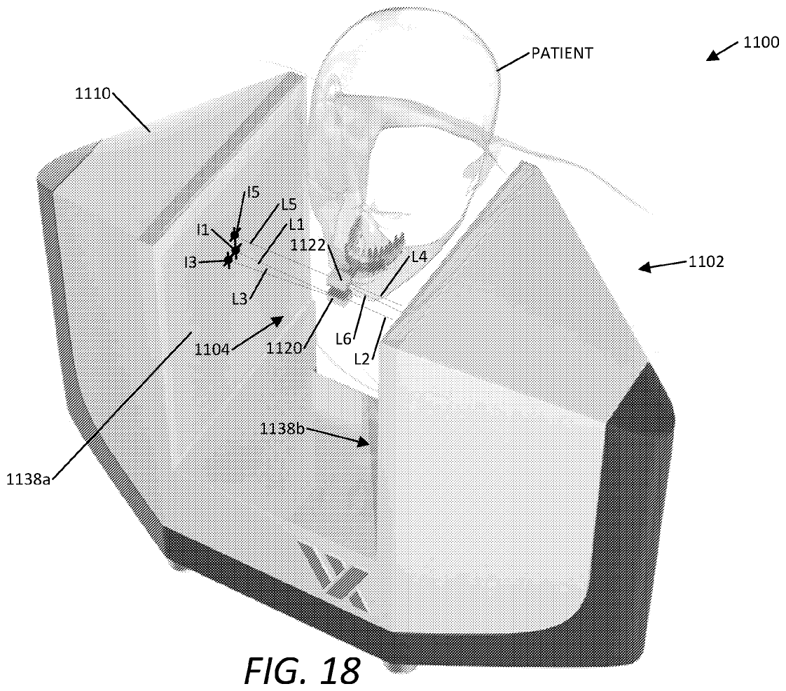

FIG. 18 illustrates an implementation of a motion capture system 1100 for capturing jaw movement in which only two screens are used. The motion capture system 1100 is an example of the system 100. The motion capture system 1100 includes an imaging system 1102 and a patient assembly 1104. In this example, the imaging system 1102 includes a housing 1110. The imaging system also includes screen 1138a and a screen 1138b (collectively referred to as screens 1138), which are positioned so as to be on opposite sides of the patient's face (e.g., screen 1138b to the left of the patient's face and screen 1138a to the right of the patient's face). In some implementations, a screen framework is disposed within the housing 1110 to position the screens 1138 with respect to each other and the housing 1110.

As can be seen in FIG. 18, this implementation does not include a screen disposed in front of the patient's face. Beneficially, by not having a screen in front of a patient's face, the system 1100 which may allow better access to the patient's face by a caregiver. Also shown, is patient assembly 1104 of the motion capture system 1100.

In at least some implementations, the patient assembly 1104 includes a clutch 1120 and a reference structure 1122, each of which include a light source assembly having three light emitters. The clutch 1120 is an example of the clutch 120 and the reference structure 1122 is an example of the reference structure 122. In FIG. 18, the clutch 1120 is attached to the patient's mandible (i.e., lower dentition) and is emitting light beams L1, L2, and L3. Light beams L1 and L3 are directed toward the screen 1138a, intersecting at intersection points I1 and I3, respectively. Light beam L2 is directed toward the screen 1138b. Although alternatives are possible, in this example, the light beams L1 and L3 are offset from each other by approximately 15 degrees. The light beams L1 and L2 are collinear and directed in opposite directions (i.e., L2 is offset from L1 by 180 degrees).

The reference structure 1122 is attached to the patient's maxilla (i.e., upper dentition) and is emitting light beams L4, L5, and L6. Light beams L4 and L6 are directed toward the screen 1138b. Light beam L5 is directed toward the screen 1138a, intersecting at intersection point 15. Although alternatives are possible, in this example, the light beams L4 and L6 are offset from each other by approximately 15 degrees. The light beams L4 and L5 are collinear and directed in opposite directions (i.e., L4 is offset from L5 by 180 degrees).

As the patient's dentition moves around, the clutch 1120 and the reference structure 1122 will move in concert with the patient's dentition, causing the lights beams to move and the intersection points to change. An optical sensing assembly of the motion capture system 1100 (e.g., cameras embedded within the housing 1110 of the system 1100 behind the screens 1138a and 1138b) may capture images of the screens 1138 so that the intersection points can be determined. The location of a first axis associated with the clutch 1120 may be identified based on the intersection points from the light beams L1 and L2. An intersection coordinate between the light beams L1 and L3 may then be determined based on the distance between the intersection points I1 and I3 on the screen 1138a. For example, the distance from the intersection point I1 along the first axis can be determined based on the distance between the points I1 and I3 and the angle between I1 and I3. As described in more detail elsewhere herein, the angle between I1 and I3 is determined for the clutch 1120 and may be stored in a data store, for example, on a non-transitory computer-readable storage medium. Using this distance, the intersection coordinate can be found, which will have a known relationship to the clutch 1120 and therefore the patient's dentition. As has been described earlier, a coordinate system for the clutch 1120 can be determined based on the intersection points too (e.g., a second axis is defined by the cross product of the first axis and a vector between the intersection points I1 and I3, and a third axis is defined by the cross product of the first axis and the second axis). In a similar manner, the position and orientation of the reference structure 1122 can be determined based on the intersection points of the light beams L4, L5, and L6 with the screens 1138a and 1138b.

In some implementations, three-dimensional coordinate systems for the clutch and the reference structure are determined using only two screens. In some implementations, the motion capture system includes only two screens and the motion capture system does not include a third screen. In some implementations, the imaging system captures images of only two screens. Some implementations identify intersection points using images captured of only two screens. For example, two intersection points from light beams emitted by a reference structure are identified on an image of the same screen.

In some implementations, a light emitter being oriented to emit light in a first direction toward the screen means the light emitter is oriented to emit light in a first direction toward the screen when the light emitter is attached to a patient (or other structure) and positioned for motion tracking with respect to the imaging system.

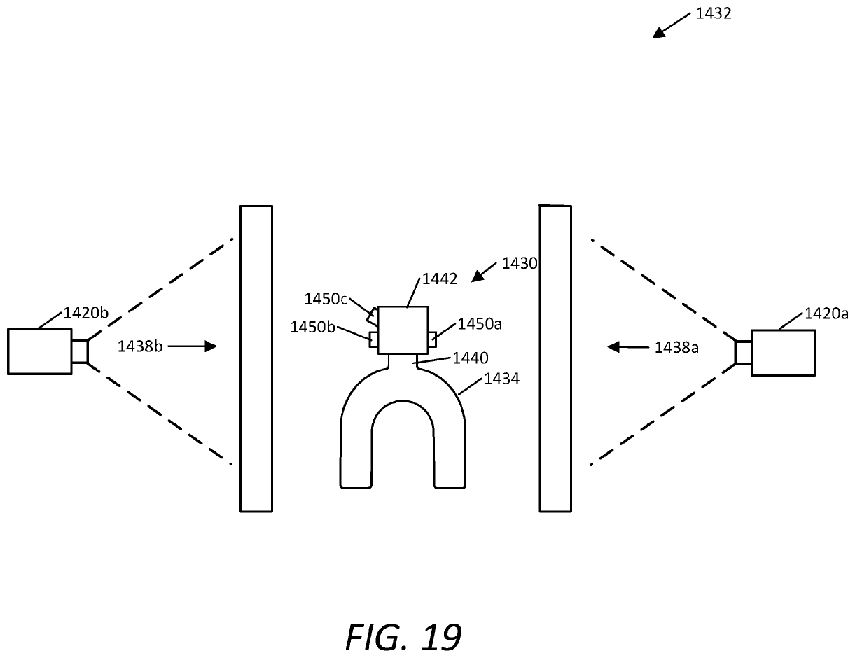

FIG. 19 illustrates a top view of an embodiment of a reference structure 1430 and an embodiment of an imaging system 1432. The reference structure 1430 is an example of the reference structure 1122. The imaging system 1432 is an example of the imaging system 1102.

The reference structure 1430 includes a dentition coupling device 1434, an extension member 1440, and a light source assembly 1442. The dentition coupling device 1434 is an example of the dentition coupling device 130 and may be similar to the example dentition coupling devices previously described with respect to embodiments of the clutch. The light source assembly 1442 is an example of the position indicator system 134. In this example, the light source assembly 1442 includes light emitters 1450a, 1450b, and 1450c (collectively referred to as light emitters 1450).

The dentition coupling device 1434 is configured to removably couple to the dentition of the patient. The dentition coupling device 1434 is coupled to the opposite arch of the patient's dentition as the clutch (e.g., the dentition coupling device 1434 of the reference structure 1430 couples to the maxillary arch when a clutch is coupled to the mandibular arch). In some embodiments, the dentition coupling device 1434 is coupled to the extension member 1440 that is configured to extend out through the patient's mouth when the dentition coupling device 1434 is coupled to the patient's dentition. The extension member 1440 may be similar to the extension member 408.

The imaging system 1432 includes screens 1438a and 1438b (referred to collectively as screens 1438), and cameras 1420a and 1420b (referred to collectively as cameras 1420). In this example, the screen 1438a is oriented parallel to the screen 1438b. In some embodiments. The imaging system 1432 may also include a screen framework (not shown) that positions the screens 1438 with respect to each other. For example, the screen framework may extend beneath the reference structure 1430 and couple to the bottoms of the screens 1438. Together, the screens 1438 and the screen framework are an example of the screen assembly 112. The cameras 1420 are an example of the optical sensing assembly 110.

The screens 1438 may be formed from a translucent material so that the points where the light beams emitted by the light source assembly 1442 intersect with the screens 1438 may be viewed from outside of the screens 1438. Images that include these points of intersection may be recorded by the cameras 1420. The motion determining device 106 may then analyze these captured images to determine the points of intersection of the light beams with the screens 1438 to determine the location of the light source assembly 1442. The position of the light source assembly of a clutch (not shown) may be determined in a similar manner.

The cameras 1420 are positioned and oriented to capture images of the screens 1438. For example, the camera 1420a is positioned and oriented to capture images of the screen 1438a, and the camera 1420b is positioned and oriented to capture images of the screen 1438b. In some embodiments, the cameras 1420 are mounted to the screen framework so that they are position and orientation of the cameras 1420 are fixed with respect to the screens. For example, each of the cameras 1420 may be coupled to the screen framework by a camera mounting assembly. In this manner, the position and orientation of the cameras 1420 relative to the screens 1438 does not change if the screen framework is moved. In some implementations, the screen framework includes a housing (e.g., as shown at 1110 in FIG. 18), within which the cameras 1420 are disposed.

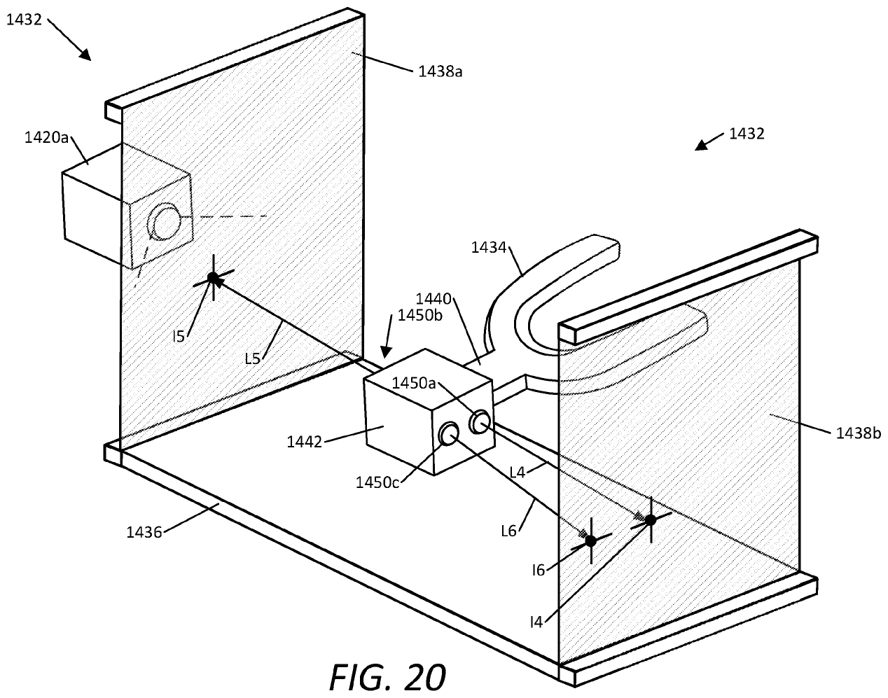

FIG. 20 illustrates a perspective view of the reference structure 1430 disposed between the screens 1438 of the imaging system 1432. The screens 1438 are joined together by a screen framework 1436 that positions and orients the screens 1438 with respect to one another. In this example, the light emitter 1450a is emitting a light beam L4, which intersects with the screen 1438b at intersection point 14; the light emitter 1450b is emitting a light beam L5, which intersects with the screen 1438a at intersection point 15; and the light emitter 1450c is emitting a light beam L6, which intersects with the screen 1438a at intersection point 16. As the position and orientation of the reference structure 1430 change relative to the screens 1438, the locations of at least some of the intersection points I4, I5, and I6 will change as well.

The camera 1420a captures images of the screen 1438a, including the intersection point I5 of the light beam L5 emitted by the light emitter 1450b. The camera 1420a may capture a video stream of these images. Similarly, although not shown in this illustration, the cameras 1420b captures images of the screens 1438b and the intersection points I4 and I6.

The captured images from the cameras 1420 are then transmitted to the motion determining device 106. The motion determining device 106 may determine the location of the intersection points I4, I5, and I6, and from those points the location of the light source assembly 1442. In some embodiments, a point of common intersection for the light beams L4, L5, and L6 is determined based on the location of the intersection points I4, I5, and I6 (e.g., the point at which the light beams intersect or would intersect if extended). Based on the determined locations of the light beams, the location and orientation of the reference structure 1430 relative to the screens 1438 can be determined.

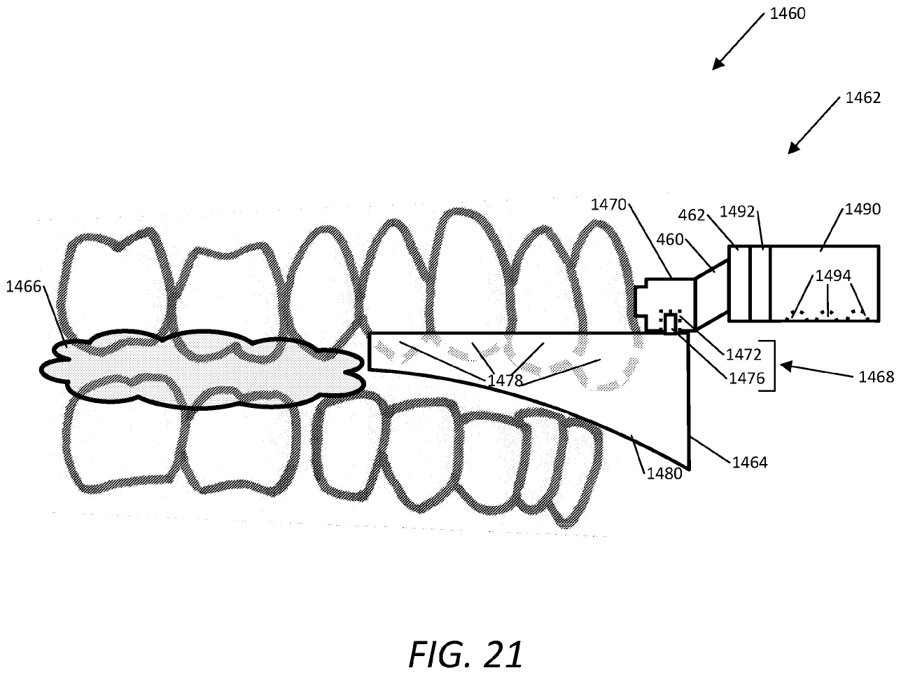

FIG. 21 is a side view of a schematic diagram of an embodiment of a dentition coupling and alignment system 1460. The dentition coupling and alignment system 1460 includes a dentition coupling device 1462, an alignment apparatus 1464, and a bite registration apparatus 1466. Also shown and identified in this figure is a mating arrangement 1468 formed by components of the dentition coupling device 1462 and components of the alignment apparatus 1464. The dentition coupling device 1462 is an example of the dentition coupling device 124 or the dentition coupling device 130. Also shown is a portion of the position indicator system 470.

The dentition coupling device 1462 may be similar to one or more of the dentition coupling devices that have been previously illustrated and described herein. Here, the dentition coupling device 1462 includes a coupling structure 1470. The coupling structure 1470 is a component that is configured to couple to a patient's dentition.

For example, the coupling structure 1470 may include an arrangement of pivot arms (not shown) to mechanically couple to a patient's dentition and may be similar to the dentition coupling devices shown in any of FIG. 4, 6-10, or 13. In some embodiments, the coupling structure 1470 includes a channel or trough (not shown) that can be filled with an impression material similar to the dentition coupling device shown in any of FIG. 12 or 15A-B. The coupling structure 1470 may be a standard size and shape that is adaptable for use on many patients.

The coupling structure 1470 may include at least some components that are custom fabricated for the patient. For example, some embodiments include at least a portion of a custom fabricated shell similar to the shell 822, which is illustrated and described with respect to FIG. 14. In some implementations, the coupling structure 1470 includes a custom-fabricated shell that fits to a portion of the buccal/labial (outward-facing) surfaces of the patient's dentition but does not cover the incisal edges or occlusal surfaces of the patient's dentition. In the embodiments where the shell does not cover the incisal edges or occlusal surface, the shell may be less likely to interfere with or impede the patient moving through a full range of j aw motion.

In this example, the dentition coupling device 1462 includes the extension member 460. As described previously herein, the extension member 460 is a rigid elongate member that is configured to protrude out through a patient's mouth when the dentition coupling device 1462 is coupled to the patient's dentition. One end of the extension member 460 is joined to the coupling structure 1470. The other end of the extension member 460 is joined to a position indicator system 1490. The position indicator system 1490 may be similar to the previously described position indicator system. Here, the extension member 460 includes an attachment assembly 462 for removably joining to a corresponding attachment assembly 1492 of the position indicator system 1490. The attachment assembly 1492 may be similar to the previously described attachment assembly 472.

In this example, the position indicator system 1490 includes fiducial markers 1494 that can be scanned to determine a position and orientation of the position indicator system 1490. Here, the fiducial markers 1494 are hemispherical pockets in a surface of the position indicator system 1490, but other types of fiducial markers, such as the other fiducial markers discussed previously herein, can be used too. The fiducial markers 1494 may be used as an alternative or back-up if the relationship between the position indicator system 1490 and the patient's dentition cannot be determined using the alignment apparatus 1464.

In this example, the coupling structure 1470 includes a receiver 1472 that is configured to receive a pin 1476 of the alignment apparatus 1464. Together, the receiver 1472 and the pin 1476 form the mating arrangement 1468. The mating arrangement 1468 is a structure configured to mate the dentition coupling device 1462 to the alignment apparatus 1464 in a pre-determined position and orientation with respect to the alignment apparatus 1464. In some embodiments, the pin 1476 and the receiver 1472 are keyed so as to fit together only in a specific orientation. Some embodiments may include multiple pins and receivers. Additionally, the mating arrangement 1468 is reversed in some implementations so that the alignment apparatus 1464 includes one or more receivers that are configured to receive one or more pins of the coupling structure 1470. In some implementations, the coupling structure 1470 includes both pins and receivers that are configured to mate with corresponding receivers and pin on the alignment apparatus 1464. In some implementations, the mating arrangement 1468 includes faces, ridges, and grooves that are disposed on the coupling structure 1470 and are configured to mate with corresponding faces, grooves, and ridges on the alignment apparatus 1464. Other types of mating structures (or detents) are possible as well.

As is described in more detail herein, the alignment apparatus 1464 is configured to fit to the patient's dentition at a pre-determined position. In combination, the alignment apparatus 1464 and the mating arrangement 1468 position the dentition coupling device 1462 in a pre-determined position and orientation with respect to the patient's dentition. Beneficially, because the relationship between the dentition coupling device 1462 and the patient's dentition is known, it may be unnecessary to capture an image or impression of the patient's dentition with the dentition coupling device 1462 attached.

The alignment apparatus 1464 is a physical structure that fits to the patient's dentition in a known relationship and mates with dentition coupling device 1462 in a known relationship. The alignment apparatus 1464 may also be referred to as an alignment jig or splint. The alignment apparatus 1464 may be placed on a patient's dentition while the dentition coupling device 1462 is secured to the patient's dentition to ensure that the dentition coupling device is secured in a specific position and orientation with respect to the patient's dentition. After the dentition coupling device 1462 is secured, the alignment apparatus may be removed so as not to interfere with the movement of the patient's dentition.

In some implementations, the alignment apparatus 1464 includes a dentition fitting surface 1478 and an opposing surface 1480. The dentition fitting surface 1478 may include one or more indents (or pockets) that fit to teeth of the patient's dentition. In some implementations, the dentition fitting surface 1478 may fit the occlusal surface and a portion of the buccal/lingual and labial surfaces (e.g., down to the heights of contour) of a patient's dentition. At least a portion of the dentition fitting surface 1478 may be a negative of the patient's dentition. The dentition fitting surface 1478 may be formed from a digital or physical impression of the patient's dentition. For example, a three-dimensional digital model of the dentition fitting surface 1478 may be formed by applying an offset of between 0 and 50 micrometers to at least a portion of the digital impression of the patient's dentition. The dentition fitting surface 1478 may be physically formed using a rapid fabrication machine such as the rapid fabrication machine 919, which is illustrated and described with respect to at least FIG. 17.

In the example shown, the opposing surface 1480 is a curved surface. In some implementations, the opposing surface 1480 may be planar. The opposing surface may be curved to deprogram that patient's dentition (e.g., to relax the jaw muscles so the jaw may rest in a position without the influence via muscle programming/memory of the patient's teeth). For example, the opposing surface 1480 may function similarly to or include physical features of a Lucia jig, leaf gauge, or bite plane. The opposing surface 1480 may be positioned and shaped to prevent contact between the posterior teeth. In some implementations, the opposing surface 1480 is curved such that anterior (front) portion of the alignment apparatus 1464 is thicker than the posterior (back) portion. In some implementations, the opposing surface 1480 provides a smooth surface that is configured to only contact the opposing central incisors.

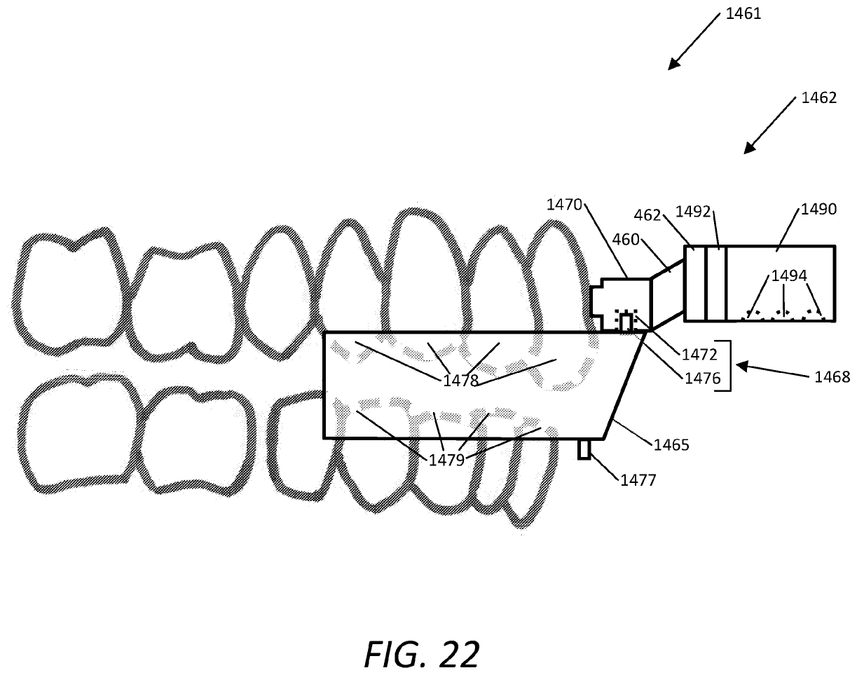

In some implementations, the opposing surface 1480 may be similar to the dentition fitting surface 1478 except that it is shaped to fit the opposing dentition. For example, the opposing surface 1480 may include tooth-shaped indentations (or pockets) to fit the teeth of the opposing dentition. In these implementations, the alignment apparatus may include mating structures on both sides to form mating apparatuses for dentition coupling devices for each arch. In this way, a single alignment apparatus may ensure a known alignment of two dentition coupling devices. FIG. 22 includes an example of an alignment apparatus 1465 that has two dentition fitting surfaces.

Some implementations may include the bite registration apparatus 1466. The bite registration apparatus 1466 is a physical structure that records the bite relationship between the patient's upper and lower teeth. The bite registration apparatus 1466 may also be referred to as a bite record. For example, the bite registration apparatus 1466 may be formed from a vinyl polysiloxane material that is initially hot and soft and can be bit into and that then hardens around the patient's teeth as it cools. The bite registration apparatus 1466 can be formed from one or more pieces of vinyl polysiloxane and can cover the full or partial dental arch. The bite registration apparatus is used to ensure a repeatable bite relationship.

Although the dentition coupling device 1462 and the alignment apparatus 1464 are shown as physically separate components, alternatives are possible. In some implementations, the alignment apparatus 1464 is removably joined to the dentition coupling device 1462. For example, the alignment apparatus 1464 may be joined to the dentition coupling device 1462 with thin connectors that can be quickly removed with a dental burr or knife so that the alignment apparatus 1464 can be separated and taken off of the patient's dentition after the dentition coupling device 1462 has been secured to the patient's dentition.

FIG. 22 is a side view of a schematic diagram of an embodiment of a dentition coupling and alignment system 1461. The dentition coupling and alignment system 1461 may be similar to the dentition coupling and alignment system 1461. However, in this example, the dentition coupling and alignment system 1461 includes the alignment apparatus 1465, which includes two dentition fitting surfaces: the dentition fitting surface 1478 and an opposing dentition fitting surface 1479. The opposing dentition fitting surface 1479 may be similar to the dentition fitting surface 1478 except that the opposing dentition fitting surface 1479 includes one or more indents (or pockets) that fit to teeth of the patient's opposing dentition (i.e., the patient's opposite dental arch). Beneficially, when both arches of the patient's dentition are fit into the alignment apparatus 1465, the patient's dentition will be positioned in a bite relationship defined by the alignment apparatus 1465. For example, some implementations do not include a bite registration apparatus 1466 because the alignment apparatus 1465 may provide a similar function.

In some implementations, the alignment apparatus 1465 includes a pin 1477. The pin 1477 may be similar to the pin 1476. The pin 1477 may be configured to mate with a receiver of a coupling structure (not shown) for the opposing dentition (i.e., the lower dentition in this figure). Like the pin 1476, the pin 1477 and the receiver may be keyed so as to fit together only in a specific orientation. Beneficially, the alignment apparatus 1465 may define a relationship between both dental arches and their respective coupling structures, which in turn may define a relationship with their respective position indicator systems.

Some implementations include an alignment apparatus that is formed integrally with a coupling structure. For example, the alignment apparatus may include a shell (e.g., similar to a portion of the shell 822 illustrated and described in FIG. 14) that is shaped to fit over a portion of a patient's dentition such as the incisal edges or occlusal surfaces of one or more teeth. The alignment apparatus may be configured to fit the patient's dentition in a pre-determined position and orientation, thereby positioning the coupling structure at a known position and orientation too. After the coupling structure is bonded to the patient's dentition, the alignment apparatus may be cut away (e.g., using a dental drill or burr) or otherwise separated from the coupling structure. In some implementations, the combined alignment apparatus and coupling structure may include perforations or cut-lines to guide or aide in the removal of the alignment apparatus. Beneficially, by removing the alignment apparatus after the coupling structure is bonded to the patient's dentition, the alignment apparatus will not interfere with the patient's bite or motion during motion capture.

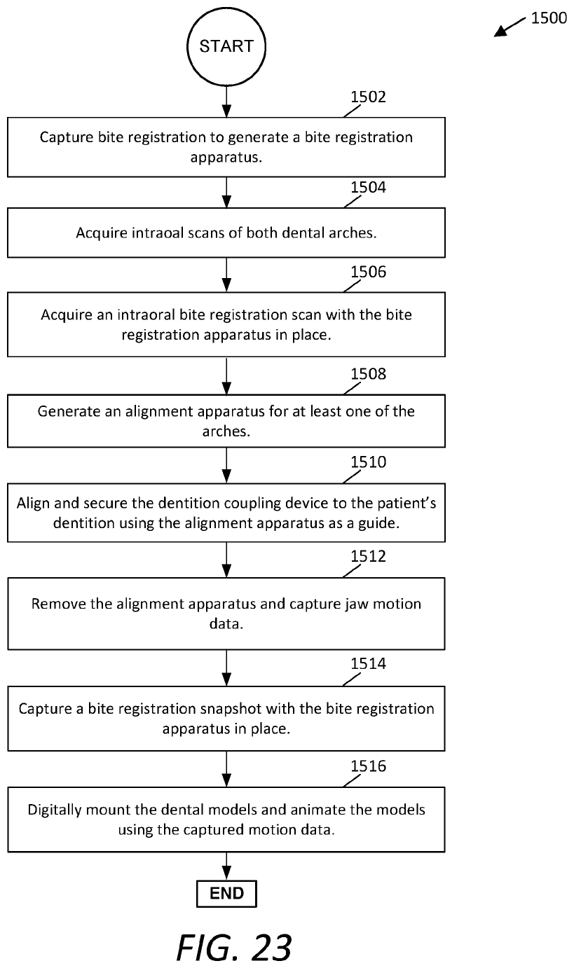

FIG. 23 is a flowchart of an example process 1500 for capturing and using jaw motion. In some embodiments, the process 1500 is performed by the system 100.

At operation 1502, a bite registration is captured to generate a bite registration apparatus, such as the bite registration apparatus 1466. The bite registration apparatus may be generated by having the patient bite into a softened vinyl polysiloxane bite registration material. The material may become softer when warmed up. The material may initially be warm when placed on the patient's teeth and then allowed to cool and harden. This bite registration apparatus captures a specific relationship between the patient's upper and lower dentition. The bite registration apparatus may be equivalent to a thin two-sided impression that when hardened has indents on both sides that fit the patient's teeth when in the captured bite.

At operation 1504, intraoral scans of both dental arches are captured. These intraoral scans may be full arch scans. These intraoral scans may be captured separately (i.e., independently) of one another. These intraoral scans can, for example, be captured in the dental impression station 906 using any type of intraoral scanner.

At operation 1506, an intraoral bite registration scan is captured with the bite registration apparatus in place to ensure the bite relationship captured in the intraoral bite registration scan matches the bite relation captured in the bite registration apparatus. The intraoral bite registration scan may, for example, include a buccal bite scan capturing the buccal surfaces of the patient's teeth from both arches as the patient's teeth are fit into the bite registration apparatus.

At operation 1508, an alignment apparatus (e.g., the alignment apparatus 1464) is fabricated for at least one of the dental arches. In some implementations, alignment apparatuses are generated for both dental arches.

As described previously, the alignment apparatus includes tooth-shaped indents or pockets that fit the occlusal surfaces of the teeth of the associated dental arch. These indents may fit the occlusal surfaces precisely. The alignment apparatus may also include locating components (e.g., pins or holes) that form a mating arrangement with the dentition coupling devices so that they can be mated repeatably. In some implementations, the alignment apparatus includes features to mate with one dentition coupling device. In some implementations, the alignment apparatus may include two sets of mating features so as to mate with and align a dentition coupling device for each dental arch. In some implementations, custom dentition coupling devices are generated for one or both arches too.

At operation 1510, the dentition coupling device is aligned and secured to the patient's dentition using the alignment apparatus as a guide. For example, the alignment apparatus may be placed on the patient's teeth so that the patient's teeth fit in the custom-sized and shaped tooth-shaped indents of the alignment apparatus. The dentition coupling device may then be positioned adjacent to the alignment apparatus using the mating arrangement to ensure a repeatable position. While in this position, the dentition coupling device is then bonded to the patient's dentition. In this manner, the dentition coupling device is bonded to the patient's dentition in a known position.

A second dentition coupling device may be secured to the opposite dentition without the use of an alignment apparatus. The process of determining the position of the second dentition coupling device relative to the dentition of the patient is explained further below.

At operation 1512, the alignment apparatus is removed and jaw motion data is captured using a position indicator system coupled to the dentition coupling device. Due to the previous operations, the dentition coupling device's position with respect to the patient's dentition may already be known and stored (e.g., by the CAD system that generated the attachment assembly). As motion data of the position indicator system is captured, that stored information that relates the dentition coupling device's position and orientation to the patient's dentition is used to determine the motion of the patient's dentition. This motion data may be related back using unique compensation data that has been determined for the position indicator system being used (e.g., data that identifies the position of a coordinate system of the position indicator system relative to the dentition coupling device). Jaw motion may be captured in many different positions or jaw motions (e.g., CO, CR, protrusive, excursive, open-close, chewing, etc.) as desired for the patient.

In some implementations, if the position of the dentition coupling device relative to the patient's dentition is unknown or suspect (e.g., the captured motion data is not consistent with the stored relationship), the relationship may be verified or updated based on capturing an intraoral scan of the patient's dentition with the dentition coupling device attached. In this case, the intraoral scan would include a portion of the patient's dentition and fiducial markers on the position indicator system. Beneficially, using the alignment apparatus may often make this intraoral scan unnecessary.

At operation 1514, a bite registration snapshot is captured with the bite registration apparatus in place. The snapshot may, for example, include the positions of the position indicator systems of both dentition coupling devices when the patient is properly biting into the bite registration apparatus.

For example, the bite registration apparatus may be placed in the patient's mouth and the patient may bite into it while a single frame snapshot of jaw motion data is captured. The operator of the motion capture system may indicate that a bite registration snapshot should be captured by actuating a button, pedal, or user-interface element on a graphical user interface. This action by the operator may flag (or annotate) a frame of the captured jaw motion data as corresponding to the patient's teeth being in contact with the bite registration apparatus.

The bite registration snapshot may then be used to determine the relationship between the second dentition coupling device and the patient's dentition. As noted previously, the snapshot will include the positions of position indicator systems attached to each of the patient's dental arches. One of the position indicator systems will be in a known relationship with its corresponding dental arch (as ensured by the alignment apparatus). This known relationship can be used to determine a position of that dental arch in the snapshot. The position of that dental arch can then be used to determine the position of the other dental arch in the snapshot based on the intraoral bite registration scan acquired at operation 1506 (which captured the relative positions of the dental arches with respect to each other when the bite registration apparatus is in place). Now, the positions of both position indicator systems and both dental arches are known in the bite registration snapshot. Those positions can be used to determine a relationship between the second dentition coupling device and its associated dentition. This relationship can then be used to infer the motion of the patient's dentition from the captured motion of the second dentition coupling device (or its attached position indicator system).

At operation 1516, the dental models are digitally mounted and animated according the captured motion data. The dental models may be generated from the intraoral scans acquired in operation 1504. Mounting the digital models may include positioning the digital models in a three-dimensional representation at relative positions determined from the captured motion data. Animating the digital models may include moving (re-rendering) the digital models in new positions in accord with the captured jaw motion data. For example, for each frame in the animation, the upper model may be positioned in space such that the upper model appears stationary but with the arch relationship accurately shown. Because the motion capture system records absolute coordinates relative to a work envelop of the system, the patient's natural head position can be recorded and used as the stationary head position.

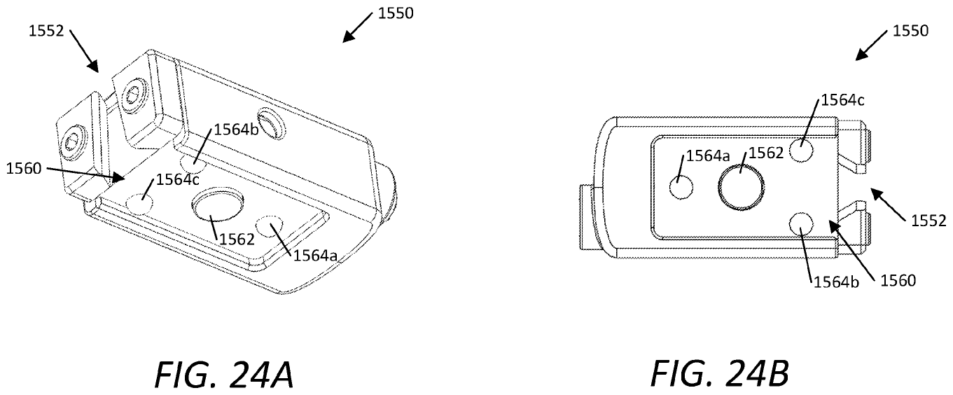

FIGS. 24A and 24B are schematic diagrams of a position indicator system 1550. FIG. 24A is an isometric view of the position indicator system 1550, and FIG. 24B is a bottom view of the position indicator system 1550. The position indicator system 1550 is an example of the position indicator system 128 and position indicator system 134. Here, the position indicator system 1550 includes a tapered dovetail connector. The tapered dovetail connector is an embodiment of an attachment assembly 472, which may removably couple (mate) with a corresponding attachment assembly of a dentition coupling device.

Here, the attachment assembly 562 includes a keyed structure 564 that is sized and shaped to slide into a corresponding keyed slot 574 of the attachment assembly 572. The keyed structure 564 may allow the attachment assembly 562 to slide in the keyed slot 574 in a specific orientation. Here, the keyed structure 564 and the keyed slot 574 have a dove-tailed structure. Other embodiments may have keyed structures with different shapes that fit a corresponding keyed slot.

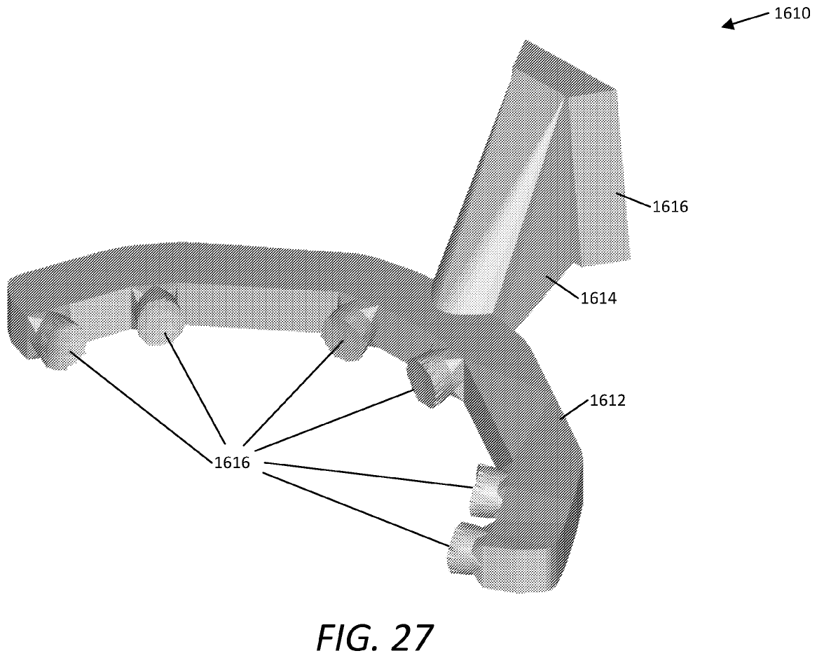

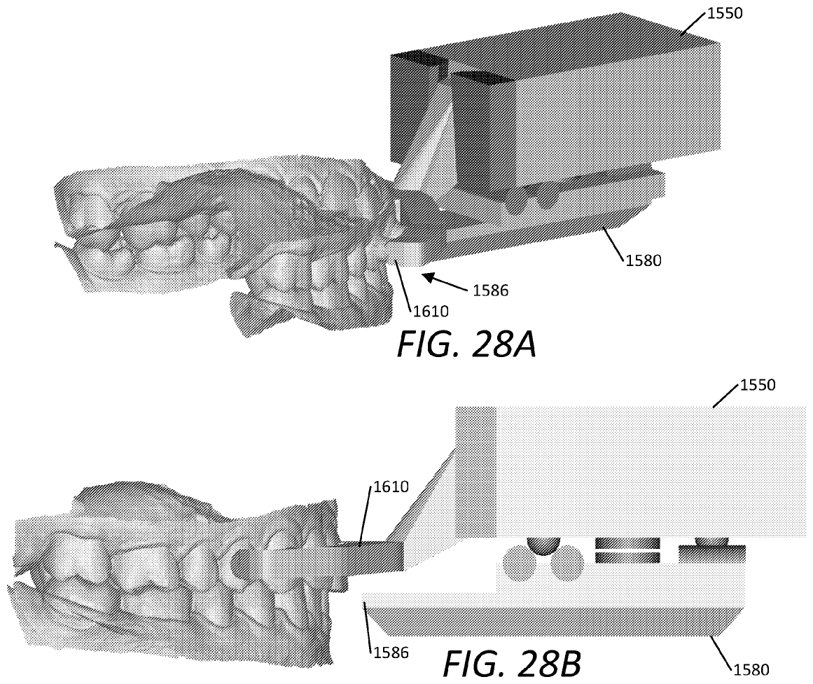

In this example, the tapered dovetail connector of the position indicator system 1550 includes a receiver 1552 for mating with a dentition coupling device. The receiver 1552 has a tapered dovetail shaped recess. In some implementations, the receiver 1552 is wider on one side (the bottom) and tapers, becoming narrow on the opposite side (the top). FIG. 27 includes an example of a dentition coupling device with a protrusion for mating with the receiver 1552; and FIGS. 28A and 28B illustrate an example dentition coupling device mated with the receiver 1552 of the position indicator system 1550.

In use, the receiver 1552 may be slid over a protrusion of a dentition coupling device. The protrusion may have a corresponding tapered dove-tail shape. The position indicator system 1550 will slide down over the protrusion until a portion of the receiver 1552 is narrow enough to contact the sides of the protrusion, preventing further sliding. Beneficially, because the position indicator system 1550 slides over the protrusion from the top, the force of gravity will pull down on the position indicator system 1550, helping keep the position indicator system 1550 in place with respect to the dentition coupling device (which would be secured to a patient's teeth). In some implementations, the position indicator system 1550 instead includes a tapered dovetail protrusion that is shaped to mate with a corresponding receiver on a dentition coupling device.

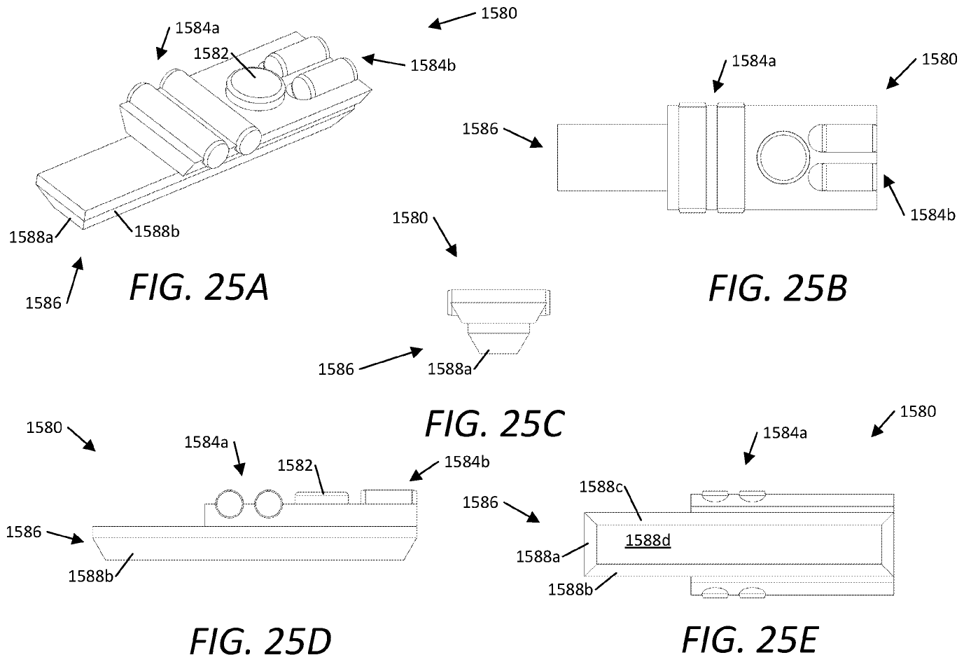

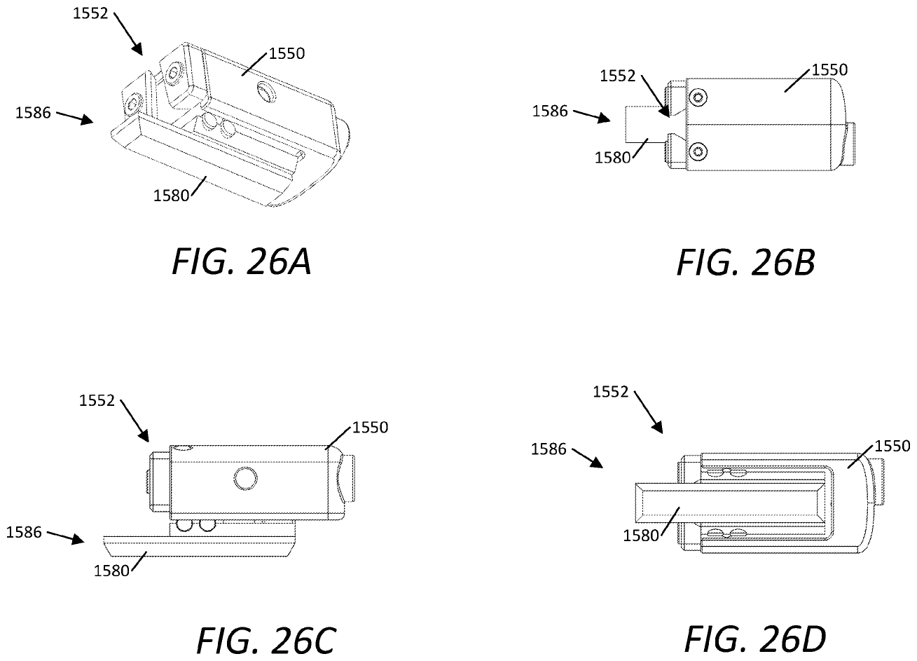

The position indicator system 1550 also includes a registration tool receiver 1560. The registration tool receiver 1560 is configured to receive and secure a registration tool. An embodiment of a registration tool is illustrated and described with respect to FIGS. 25A-25E. Additionally, FIGS. 26A-26D illustrate examples of a registration tool coupled to a position indicator system.

The registration tool receiver 1560 may be disposed on a side of a housing of the position indicator system. For example, on a position indicator system intended for use on a patient's upper dentition, such as the position indicator system 1550, the registration tool receiver 1560 may be disposed on a bottom side (i.e., downward-facing side when connected to a dentition coupling device, side nearer to the occlusal surfaces/occlusal plane of the patient's upper teeth). On a position indicator system intended for use on a patient's lower dentition, a registration tool receiver may be disposed on a top side (i.e., an upward-facing side when connected to a dentition coupling device, a side nearer to the occlusal surfaces/occlusal plane of the lower teeth). In some embodiments, the registration tool receiver 1560 may include an indent that is sized and shaped to fit around a portion of a registration tool.

Here, the registration tool receiver 1560 includes a connector 1562 and alignment features 1564a, 1564b, and 1564c (referred to collectively as alignment features 1564). Here, the connector 1562 provides a force to hold the registration tool in place. For example, the connector 1562 may include a magnet or a ferrous button that may couple with a corresponding magnetic structure on the registration tool. The alignment features 1564 are structural features that mate with corresponding structural features on the registration tool when it is disposed in a pre-determined alignment (e.g., position and orientation) with respect to the position indicator system 1550. In this manner, the alignment features 1564 help to ensure the registration tool can be connected to the position indicator system 1550 in a repeatable manner. In this example, the alignment features 1564 are hemispheres that protrude from the position indicator system 1550 and are configured to mate with pairs of cylinders protruding from the registration tool.

FIGS. 25A-E are schematic diagrams of a registration tool 1580. FIG. 25A is an isometric view; FIG. 25B is a top view; FIG. 25C is a front view; FIG. 25D is a side view; and FIG. 25E is a top view. The registration tool 1580 is configured to removably couple to a position indicator system, such as the position indicator system 1550. The registration tool 1580 may be a rigid elongate structure that is configured to couple to the position indicator system 1550 in a pre-determined position and orientation, and to extend toward the patient's dentition so as to position a scan end 1586 near the patient's dentition. In some embodiments, the scan end is opposite an end that couples (a coupling end) to the position indicator system. The scan end 1586 is configured to be scanned by an intraoral scanner during a scan of the patient's dentition.

The scan end 1586 includes several scan features that are shaped so as to allow for identification within three-dimensional scan data captured during an intraoral scan. In this example, the scan end 1586 include scan feature 1588a (front planar scan feature), scan feature 1588b (first lateral planar scan feature), scan feature 1588c (second lateral planar scan feature), and scan feature 1588d (top planar scan feature) (referred to collectively as scan features 1588). Here, the scan features 1588 are planar. When scanned, plane fitting techniques may be used to identify the location of the scan features 1588. The intersections of the planes may then be determined and used to determine the position and orientation of the registration tool 1580, which in turn can be used to determine the position and orientation of a position indicator system.

In this example, the registration tool 1580 includes a connector 1582. The connector 1582 provides a force to join the registration tool 1580 in place on a position indicator system. The connector 1582 may include a magnet or a ferrous button that may couple with a corresponding magnetic structure on the position indicator system. For example, the connector 1582 may magnetically couple to the connector 1562 of the position indicator system 1550.

In this example, the registration tool 1580 also includes alignment feature 1584a and alignment feature 1584b (referred to collectively as alignment features 1584). The alignment features 1584 are structural features that mate with corresponding structural features on a position indicator system when the registration tool 1580 is disposed in a pre-determined alignment (e.g., position and orientation) with respect to the position indicator system 1550. In this manner, the alignment features 1584 help to ensure the registration tool 1580 can be connected to a position indicator system in a repeatable manner (e.g., so that the position of the registration tool 1580 is usable to determine the position of coupled position indicator system).

In this example, the alignment features 1584 are pairs of hemicylinders that protrude from the position indicator system 1550 and are configured to mate with one or more hemispheres protruding from a position indicator system. For example, the alignment feature 1584a of the registration tool 1580 may mate with the alignment feature 1564a of the position indicator system 1550 (e.g., the hemisphere of the alignment feature 1564a will be positioned between the hemicylinders of the alignment feature 1584a).

FIGS. 26A-26D illustrate examples of the registration tool 1580 coupled to the position indicator system 1550. FIG. 26A is an isometric view; FIG. 26B is a top view; FIG. 26C is a side view; and FIG. 26D is a bottom view. As can be seen in these figures, the scan end 1586 of the registration tool 1580 extends out in front of (i.e., towards the patient's dentition when worn) the receiver 1552 of the position indicator system 1550.

FIG. 27 is an isometric view of an example dentition coupling device 1610. The dentition coupling device 1610 is an example of the dentition coupling device 130 or the dentition coupling device 124. In this example, the dentition coupling device 1610 includes an arch structure 1612 and bonding protrusions 1616. It should be understood that in some embodiments, the dentition coupling device 1610 may, as appropriate, include aspects of the other dentition coupling devices discussed herein.

The dentition coupling device 1610 also includes an extension member 1614 and a tapered dovetail connector with a protrusion 1616. The extension member 1614 may be similar to the extension member 408 or the other extension members described herein. The protrusion 1616 has a tapered dovetail shape that is wider on the bottom and narrower on the top. As described previously, this arrangement allows a corresponding recess of a position indicator system to be slid down over the protrusion 1616 until the width of the protrusion 1616 prevents further downward movement of the position indicator system. Thereafter, the force of gravity will help hold the position indicator system in that position.

FIGS. 28A and 28B illustrate examples of a patient's dentition with the dentition coupling device 1610 coupled thereto. FIG. 28A is an isometric view and FIG. 28B is a side view. The dentition coupling device 1610 is coupled to the position indicator system 1550, which is coupled to the registration tool 1580. As can be seen, the scan end 1586 of the registration tool 1580 is positioned near the patient's incisal edges of the upper dentition. This positioning of the scan end 1586 is near enough to the dentition to be picked up during an intraoral scan of the dentition. In some implementations, a small amount of putty, wax, paper, or another substance may be placed between the scan end 1586 and the dentition to further facilitate inclusion of the registration tool 1580 in scan data captured using an intraoral scanner. The registration tool may removed (detached) after the scan end has been scanned. Once the scan end 1586 is scanned in relation to the patient's dentition, the position (location and orientation) of the registration tool can be determined as previously described by, for example, fitting planes to the data. From the determined position of the registration tool 1580, the position of the position indicator system 1550 can be determined. In this manner, the position of the position indicator system 1550 can be determined with respect to the patient's dentition. Then as described elsewhere, the motion of the position indicator system 1550 can be tracked and related back to the motion of the patient's dentition.

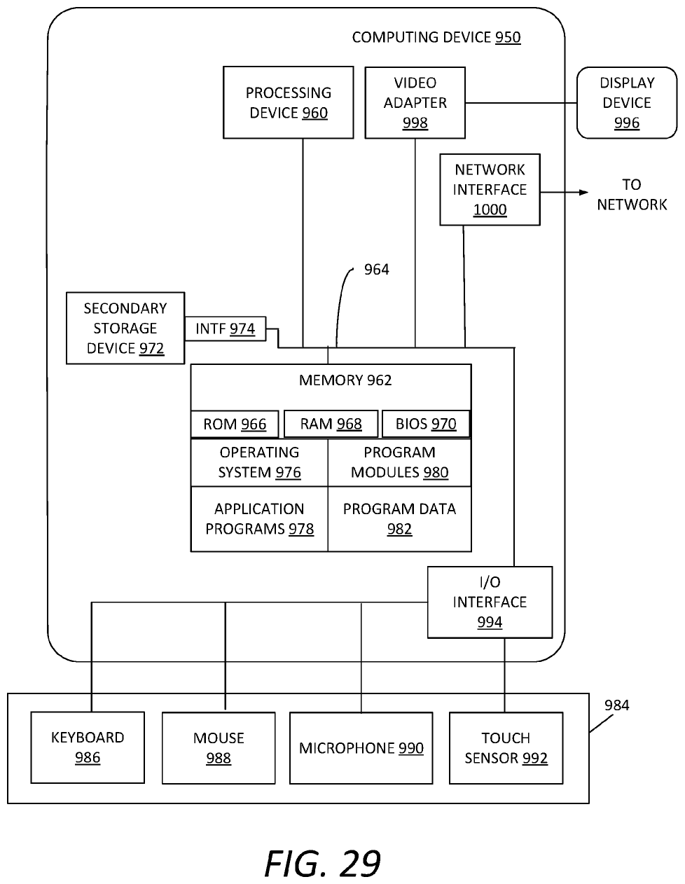

FIG. 29 illustrates an example architecture of a computing device 950 that can be used to implement aspects of the present disclosure, including any of the plurality of computing devices described herein, such as a computing device of the motion determining device 106, the design system 916, or any other computing devices that may be utilized in the various possible embodiments.

The computing device illustrated in FIG. 29 can be used to execute the operating system, application programs, and software modules described herein.

The computing device 950 includes, in some embodiments, at least one processing device 960, such as a central processing unit (CPU). A variety of processing devices are available from a variety of manufacturers, for example, Intel or Advanced Micro Devices. In this example, the computing device 950 also includes a system memory 962, and a system bus 964 that couples various system components including the system memory 962 to the processing device 960. The system bus 964 is one of any number of types of bus structures including a memory bus, or memory controller; a peripheral bus; and a local bus using any of a variety of bus architectures.

Examples of computing devices suitable for the computing device 950 include a desktop computer, a laptop computer, a tablet computer, a mobile computing device (such as a smart phone, an iPod® or iPad® mobile digital device, or other mobile devices), or other devices configured to process digital instructions.

The system memory 962 includes read only memory 966 and random-access memory 968. A basic input/output system 970 containing the basic routines that act to transfer information within computing device 950, such as during start up, is typically stored in the read only memory 966.

The computing device 950 also includes a secondary storage device 972 in some embodiments, such as a hard disk drive, for storing digital data. The secondary storage device 972 is connected to the system bus 964 by a secondary storage interface 974. The secondary storage devices 972 and their associated computer readable media provide nonvolatile storage of computer readable instructions (including application programs and program modules), data structures, and other data for the computing device 950.

Although the example environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory computer-readable media. Additionally, such computer readable storage media can include local storage or cloud-based storage.

A number of program modules can be stored in secondary storage device 972 or system memory 962, including an operating system 976, one or more application programs 978, other program modules 980 (such as the software engines described herein), and program data 982. The computing device 950 can utilize any suitable operating system, such as Microsoft Windows™, Google Chrome™ OS or Android, Apple OS, Unix, or Linux and variants and any other operating system suitable for a computing device. Other examples can include Microsoft, Google, or Apple operating systems, or any other suitable operating system used in tablet computing devices.

In some embodiments, a user provides inputs to the computing device 950 through one or more input devices 984. Examples of input devices 984 include a keyboard 986, mouse 988, microphone 990, and touch sensor 992 (such as a touchpad or touch sensitive display). Other embodiments include other input devices 984. The input devices are often connected to the processing device 960 through an input/output interface 994 that is coupled to the system bus 964. These input devices 984 can be connected by any number of input/output interfaces, such as a parallel port, serial port, game port, or a universal serial bus. Wireless communication between input devices and the interface 994 is possible as well, and includes infrared, BLUETOOTH® wireless technology, 802.11a/b/g/n, cellular, ultra-wideband (UWB), ZigBee, or other radio frequency communication systems in some possible embodiments.

In this example embodiment, a display device 996, such as a monitor, liquid crystal display device, projector, or touch sensitive display device, is also connected to the system bus 964 via an interface, such as a video adapter 998. In addition to the display device 996, the computing device 950 can include various other peripheral devices (not shown), such as speakers or a printer.

When used in a local area networking environment or a wide area networking environment (such as the Internet), the computing device 950 is typically connected to the network through a network interface 1000, such as an Ethernet interface or WiFi interface. Other possible embodiments use other communication devices. For example, some embodiments of the computing device 950 include a modem for communicating across the network.

The computing device 950 typically includes at least some form of computer readable media. Computer readable media includes any available media that can be accessed by the computing device 950. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 950.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 29 is also an example of programmable electronics, which may include one or more such computing devices, and when multiple computing devices are included, such computing devices can be coupled together with a suitable data communication network so as to collectively perform the various functions, methods, or operations disclosed herein.

In a non-limiting example, a clutch is attached to a light emitter assembly (or projector) that projects three laser beams. Two of the laser beams are co-linear and project in opposite directions. The third laser beam is perpendicular to the first two laser beams. All three laser beams are co-planar. A clutch and light emitter assembly is attached to each arch of the patient's dentition. The light emitters project laser dots onto three translucent screens such that one upper arch and one lower arch laser dot appears on each screen. Each screen is viewed by a separate video camera. The cameras are synchronized such that they capture frames simultaneously or nearly simultaneously. In some embodiments, the cameras include a synchronization input port and the system includes a synchronization system that is configured to simultaneously transmit a signal to the synchronization input port of each of the cameras, causing the cameras to begin to capture video synchronously.

In some embodiments, variations in the alignment of the screens to each other and the cameras is compensated for in software. Camera field-of-view distortion may also be compensated for in software. The upper arch dot is distinguished from the lower arch dot on each screen using one or more of the following techniques: upper arch dots are assumed to be those highest on the screens and lower arch dots are assumed to be those lowest on the screens; upper arch dots are projected in one color and lower arch dots are projected in a different color; and dots are pulsed such that upper arch dots are projected and imaged after which lower arch dots are projected and imaged. Other implementations are possible too.

An example motion capture system (or motion mapping device) may include two small laser projectors that are temporarily attached to a patient's upper and lower dentition via disposable clutches for the duration of a recording. The projectors are example of the position indicator system. Each projector projects laser spots onto two translucent screens mounted in a frame that is external to the patient. The laser spots are examples of intersection points. The frame with the screens mounted therein is an example of a screen assembly. Cameras mounted inside the external frame track the position of the laser spots. The cameras are an example of an optical sensing assembly. These laser spot locations are then used to construct a three-dimensional coordinate system for each projector. Each three-dimensional coordinate system, updated for each new video frame, is used to animate a three-dimensional full arch digital model previously obtained from a three-dimensional intra-oral scanner or physical impression.

To optimize accuracy, a unique field-of-view (FOV) calibration may be performed for each camera lens to correct lens distortion. A unique calibration may also be done for the frame of the screen assembly to correct mechanical errors. The use of two projectors allows the system to accurately report the position and orientation differences between the two projectors. This, in turn, allows a patient's head to move during a recording without affecting the relative motion recorded between the patient's upper and lower arches.

3D Platform

Implementations described herein may use a 3D Platform to develop a variety of 3D applications able to run natively on popular operating systems (e.g., Microsoft Windows, Apple OS-X, etc.). The software may be written in any language such as object-oriented C++ and may use industry standard Qt and OpenGL libraries to provide user interface widgets (menus, icons, etc.) and 3D interactive graphics, respectively.

This 3D platform may be used to provide a 3D motion capture user interface for the motion mapping technology device. This same 3D platform may also be used to provide 3D data processing applications geared toward specific dental needs such as:
Treatment planning;
Crown and bridge design;
Digital setups (orthodontic simulations) for aligners and indirect bonding;
Implant location planning for implant supported dentures; and
Splints for oral surgery and TMJ disorder treatment.

The 3D platform may include a rich set of core library tools that operate on some or all of the following types of data:
Polylines—ordered sets of 3D points;
Splines—smooth 3D curves;
Meshes—networks of interconnected 3D triangles;
Planes—3D planes;
Datums—3D locations/coordinate systems;
Dimensions—3D distance and angle annotation; and
Notes—Used to document important features on a 3D model.

The 3D platform may include tools to provide functions to do one or more of the following: copy, move, rotate, translate, scale, trim, merge, intersect, offset, smooth, and filter. Many other tools may also be provided.

Implementations of the 3D platform may also include other library tools to allow the application developer to:
Capture and record live video data from digital cameras;
Correct 3D opto-mechanical errors via calibration;
Generate formatted reports;
Read and write all 3D data in an efficient, proprietary or non-proprietary binary file format;
Read and write 3D mesh data using open standard STL files; and
Generate files used to 3D print or CNC mill physical objects.

Implementations may also include higher level tools that are specifically tailored to dental applications. For instance, instead of manipulating a mesh, spline or plane, the application developer can more naturally manipulate a “tooth”, “arch wire”, or “occlusal plane”. These higher-level tools may include features to:
Segment/isolate teeth from a full arch model;
Reposition teeth to simulate orthodontic or surgical treatment;
Place orthodontic brackets on teeth;
Reshape teeth to simulate restorative dental work; and
Measure anatomical features and report critical distances/angles/ratios.

Having a “core” foundation upon which the motion mapping technology dental applications are built provides tremendous flexibility to provide “specialist modules” that target specific types of dental applications (restorative, orthodontics, oral surgery, etc.) or even applications outside of dentistry (orthopedics, product engineering/testing, animation, etc.) with relative ease.

Case Portal

Some implementations include a case portal system that provides a means for clinicians and laboratories to:

Share patient records (motion data, 3D models, photos, x-rays, treatment plans, etc.) via the internet in a Health Insurance Portability and Accountability Act (HIPAA) compliant manner;

Limit access to records based on client-defined group permission policies; and

Manage case work via a messaging system that provides automated notifications/reminders.

Implementations of the case portal system may provide a web interface that has sheets (tabs) for each type of record (3D models, x-rays, photos, etc.) taken on a patient. Within each sheet stacks may be used to further organize records chronologically. For instance, the “Photos” sheet might contain an “Anterior” stack that includes anterior photos taken of a patient at different points in time.

Since patient record files can be very large, they may be stored on a local server in the clinic that is then synched periodically with a cloud server. This provides rapid access to local records and offers the convenience and data security of remote cloud storage.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

Some non-limiting examples are provided below:

Example 1: An apparatus comprising: a base region; an extension member connected to the base region and configured to protrude out from a mouth of a patient, the extension member including an attachment assembly for removably connecting with a position indicator system; a first arm configured to couple to a first side of a dental arch of the patient; and a second arm configured to couple to a second side of the dental arch.

Example 2: The apparatus of example 1, wherein the first arm is fixedly connected to the base.

Example 3: The apparatus of any one of examples 1 or 2, wherein the second arm is pivotally connected to the base.

Example 4: The apparatus of any one of examples 1-3, wherein the first arm and the second arm form an arch.

Example 5: The apparatus of example 4, further comprising the position indicator system, wherein the position indicating system is removably connected to the attachment assembly.

Example 6: The apparatus of example 5, wherein the position indicator system includes: a housing; a first light emitter disposed within the housing and oriented to emit light in a first direction; a second light emitter disposed within the housing and oriented to emit light in a second direction, the second direction being collinear with and opposite to the first direction; and a third light emitter disposed within the housing and oriented to emit light in a third direction, the third direction being different than the first direction and the second direction.

Example 7: The apparatus of any one of examples 4-6, wherein the attachment assembly includes a tapered dovetail connector.

Example 8: The apparatus of example 7, wherein the position indicator system is a maxillary position indicator system and the tapered dovetail connector is narrower on a top side and wider on a bottom side.

Example 9: The apparatus of any one of examples 4-8, wherein the position indicator system further includes a registration tool receiver, the registration tool receiver including at least one connector to provide force to removably hold a registration tool in place.

Example 10: The apparatus of example 9, wherein the at least one connector is a magnetic structure.

Example 11: The apparatus of any one of examples 9 and 10, wherein the registration tool receiver further includes at least one alignment feature, the at least one alignment feature being configured to mate with a corresponding alignment feature of the registration tool.

Example 12: The apparatus of example 11, wherein the at least one alignment feature includes a hemisphere or a pair of hemicylinders.

Example 13: The apparatus of any one of examples 9-12, further comprising the registration tool, wherein the registration tool is removably coupled to the registration tool receiver.

Example 14: The apparatus of example 13, wherein the registration tool includes: a coupling end that includes a connector for coupling to the registration tool receiver; and a scan end that is configured to be scanned by an intraoral scanner.

Example 15: The apparatus of example 14, wherein the registration tool is a rigid elongate structure, and the scan end is opposite the coupling end.

Example 16: The apparatus of example 15, wherein the rigid elongate structure is oriented to position the scan end near a patient's teeth when the registration tool is coupled to the registration tool receiver of a position indicator system when the apparatus is coupled to a patient's dentition.

Example 17: The apparatus of any one of examples 14-16, wherein the coupling end includes at least one alignment feature, the at least one alignment feature being configured to mate with a corresponding alignment feature of the registration tool receiver.

Example 18: The apparatus of example 17, wherein the at least one alignment feature includes a hemisphere or a pair of hemicylinders.

Example 19: The apparatus of any one of examples 14-18, wherein the scan end includes at least one scan feature shaped so as to allow for identification within three-dimensional scan data.

Example 20: The apparatus of example 19, wherein the at least one scan feature includes a top planar scan feature, a lateral scan feature, and a front planar scan feature.

Example 21: The apparatus of any of examples 1-20, further comprising an alignment apparatus.

Example 22: The apparatus of example 21, wherein the alignment apparatus includes at least one dentition fitting surface configured to fit to a surface of the patient's dentition.

Example 23: The apparatus of example 22, wherein the dentition fitting surface is a custom-fabricated dentition fitting surface for the patient.

Example 24: The apparatus of any of one of examples 22 or 23, wherein the dentition fitting surface includes one or more indents that fit to teeth of the patient's dentition.

Example 25: The apparatus of any of one of examples 22-24, wherein the dentition fitting surface includes a surface configured to follow a contour of a labial surface of a tooth of the patient's dentition.

Example 26: The apparatus of any of one of examples 22-25, wherein the at least one dentition fitting surface includes a first dentition fitting surface configured to fit a first arch of the patient's dentition and a second dentition fitting surface configured to fit a second arch fo the patient's dentition.

Example 27: The apparatus of any one of examples 22-25, wherein the alignment apparatus further includes an opposing surface, the opposing surface being positioned opposite the dentition fitting surface.

Example 28: The apparatus of example 27, wherein the opposing surface is shaped to deprogram the patient's dentition.

Example 29: The apparatus of any of one of examples 21-28, further comprising a mating arrangement for removably connecting the alignment apparatus to the dentition coupling the base region.

Example 30: The apparatus of example 29, wherein the mating arrangement includes a keyed pin and receiver for the keyed pin.

Example 31: A method comprising: coupling a dentition coupling device of a clutch to a first dental arch of a patient's dentition; attaching a registration tool to a position indicator system of the clutch; capturing three-dimensional scan data that includes a portion of the first dental arch and at least a portion of the registration tool; and determining the position of the registration tool relative to the first dental arch based on the three-dimensional scan data.

Example 32: The method of example 31, wherein the capturing three-dimensional scan data includes capturing three-dimensional scan data with an intraoral scanner.

Example 33: The method of any one of examples 31 and 32, wherein the determining the position of the registration tool relative to the first dental arch includes identifying scan features of the registration tool within the captured three-dimensional scan data.

Example 34: The method of example 33, wherein the identifying scan features of the registration tool includes using plane fitting to identify the scan features.

Example 35: The method of example 34, wherein the scan features include at least three planar scan features.

Example 36: The method of any one of examples 31-35, wherein the determining the position includes determining a location and an orientation relative to the first dental arch.

Example 37: The method of any one of examples 31-36, further comprising: detaching the registration tool from the position indicator system; capturing motion data using the position indicator system; and determining motion of the first dental arch based on captured motion data and the determined position of the registration tool relative to the first dental arch.

Example 38: The method of example 37, wherein the determining motion of the first dental arch based on captured motion data and the determined position of the registration tool relative to the first dental arch includes determining the position of the position indicator system relative to the first dental arch based on the determined position of the registration tool relative to the first dental arch.

Example 39: A method comprising: capturing three-dimensional scan data of a first dental arch of a patient; generating an alignment apparatus for the first dental arch based on the captured three-dimensional scan data; aligning a first dentition coupling device to the first dental arch using the alignment apparatus; securing the first dentition coupling device to the first dental arch; removing the alignment apparatus; capturing motion data of a first position indicator system coupled to the first dentition coupling device; and determining motion of the first dental arch based on the captured motion data of the first position indicator system.

Example 40: The method of example 39, wherein the generating an alignment apparatus includes fabricating the alignment apparatus using rapid manufacturing technology.

Example 41: The method of any one of examples 39 or 40, wherein the determining motion of the first dental arch based on the captured motion data includes: determining a relative position of the first position indicator system relative to the first dental arch based on the alignment apparatus; and determining the motion of the first dental arch based on the determined relative position of the first position indicator system and the captured motion data.

Example 42: The method of any one of examples 39-41, further comprising: generating a bite registration apparatus representing the first dental arch in a specific bite position relative to a second dental arch of the patient; capturing three-dimensional scan data of the second dental arch; capturing a bite registration scan of a portion of the first dental arch and the second dental arch using the bite registration apparatus to position the first dental arch in the specific bite position relative to the second dental arch; securing a second dentition coupling device to the second dental arch; using the first position indicator and the second position indicator to capture a bite registration snapshot using the bite registration apparatus to position the first dental arch in the specific bite position relative to the second dental arch; capturing motion data of a second position indicator system coupled to the second dentition coupling device, the motion data of the second position indicator system being captured simultaneously with the capturing motion data of the first position indicator system; and determining motion of the second dental arch based on the bite registration snapshot and the captured motion data of the second dental arch.

Example 43: The method of example 42, wherein the bite registration snapshot includes a frame of motion data representing a specific position of the first position indicator system and a frame of motion data representing a specific position of the second position indicator system.

Example 44: The method of any one of examples 42 or 43, wherein the determining the motion of the second dental arch based on the bite registration snapshot and the captured motion data of the second position indicator system: determining a relative position of the first position indicator system relative to the first dental arch based on the alignment apparatus; determining a relative position of the second position indicator system relative to the first position indicator system based on the bite registration snapshot; determining a relative position of the second position indicator system to the first dental arch based on the determined relative position of the second position indicator system to the first position indicator system and determined relative position of the first position indicator system relative to the first dental arch; determining a relative position of the second dental arch relative to the first dental arch based on the bite registration scan; determining a relative position of the second position indicator system relative to the second dental arch based on the determined relative position of the second dental arch to the first dental arch and the determined relative position of the second position indicator to the first dental arch; and determining the motion of the second dental arch based on the determined relative position of the second position indicator system to the second dental arch and the captured motion data of the second position indicator system.

1. An apparatus comprising:
a base region;
an extension member connected to the base region and configured to protrude out from a mouth of a patient, the extension member including an attachment assembly for removably connecting with a position indicator system;
a first arm configured to couple to a first side of a dental arch of the patient; and
a second arm configured to couple to a second side of the dental arch.

2. (canceled)

3. (canceled)

4. (canceled)

5. (canceled)

6. The apparatus of claim 1, wherein the position indicator system includes:
a housing;
a first light emitter disposed within the housing and oriented to emit light in a first direction;
a second light emitter disposed within the housing and oriented to emit light in a second direction, the second direction being collinear with and opposite to the first direction; and
a third light emitter disposed within the housing and oriented to emit light in a third direction, the third direction being different than the first direction and the second direction.

7. The apparatus of claim 6, wherein the attachment assembly includes a tapered dovetail connector.

8. The apparatus of claim 7, wherein the position indicator system is a maxillary position indicator system and the tapered dovetail connector is narrower on a top side and wider on a bottom side.

9. The apparatus of claim 1, wherein the position indicator system further includes a registration tool receiver, the registration tool receiver including at least one connector to provide force to removably hold a registration tool in place.

10. The apparatus of claim 9, wherein the at least one connector is a magnetic structure.

11. The apparatus of any one of claims 9 and 10, wherein the registration tool receiver further includes at least one alignment feature, the at least one alignment feature being configured to mate with a corresponding alignment feature of the registration tool.

12. The apparatus of claim 11, wherein the at least one alignment feature includes a hemisphere or a pair of hemicylinders.

13. (canceled)

14. The apparatus of claim 11, wherein the registration tool is a rigid elongate structure that includes:
a coupling end that includes a connector for coupling to the registration tool receiver; and
a scan end that is configured to be scanned by an intraoral scanner, wherein the scan end is opposite the coupling end.

15. (canceled)

16. (canceled)

17. (canceled)

18. (canceled)

19. The apparatus of claim 14, wherein the scan end includes at least one scan feature shaped so as to allow for identification within three-dimensional scan data.

20. The apparatus of claim 19, wherein the at least one scan feature includes a top planar scan feature, a lateral scan feature, and a front planar scan feature.

21. (canceled)

22. (canceled)

23. (canceled)

24. (canceled)

25. (canceled)

26. (canceled)

27. (canceled)

28. (canceled)

29. (canceled)

30. (canceled)

31. A method comprising:
coupling a dentition coupling device of a clutch to a first dental arch of a patient's dentition;
attaching a registration tool to a position indicator system of the clutch;
capturing three-dimensional scan data that includes a portion of the first dental arch and at least a portion of the registration tool; and
determining the position of the registration tool relative to the first dental arch based on the three-dimensional scan data.

32. (canceled)

33. The method of claim 31, wherein the determining the position of the registration tool relative to the first dental arch includes identifying scan features of the registration tool within the captured three-dimensional scan data.

34. (canceled)

35. (canceled)

36. (canceled)

37. The method of claim 31, further comprising:
detaching the registration tool from the position indicator system;
capturing motion data using the position indicator system; and
determining motion of the first dental arch based on captured motion data and the determined position of the registration tool relative to the first dental arch.

38. The method of claim 37, wherein the determining motion of the first dental arch based on captured motion data and the determined position of the registration tool relative to the first dental arch includes determining the position of the position indicator system relative to the first dental arch based on the determined position of the registration tool relative to the first dental arch.

39. A method comprising:
capturing three-dimensional scan data of a first dental arch of a patient;
generating an alignment apparatus for the first dental arch based on the captured three-dimensional scan data;
aligning a first dentition coupling device to the first dental arch using the alignment apparatus;
securing the first dentition coupling device to the first dental arch;
removing the alignment apparatus;
capturing motion data of a first position indicator system coupled to the first dentition coupling device; and
determining motion of the first dental arch based on the captured motion data of the first position indicator system.

40. (canceled)

41. The method of claim 39, wherein the determining motion of the first dental arch based on the captured motion data includes:
determining a relative position of the first position indicator system relative to the first dental arch based on the alignment apparatus; and
determining the motion of the first dental arch based on the determined relative position of the first position indicator system and the captured motion data.

42. The method of claim 39, further comprising:
generating a bite registration apparatus representing the first dental arch in a specific bite position relative to a second dental arch of the patient;
capturing three-dimensional scan data of the second dental arch;
capturing a bite registration scan of a portion of the first dental arch and the second dental arch using the bite registration apparatus to position the first dental arch in the specific bite position relative to the second dental arch;
securing a second dentition coupling device to the second dental arch;
using the first position indicator and the second position indicator to capture a bite registration snapshot using the bite registration apparatus to position the first dental arch in the specific bite position relative to the second dental arch;
capturing motion data of a second position indicator system coupled to the second dentition coupling device, the motion data of the second position indicator system being captured simultaneously with the capturing motion data of the first position indicator system; and
determining motion of the second dental arch based on the bite registration snapshot and the captured motion data of the second dental arch.

43. The method of claim 42, wherein the bite registration snapshot includes a frame of motion data representing a specific position of the first position indicator system and a frame of motion data representing a specific position of the second position indicator system.

44. The method of claim 42, wherein the determining the motion of the second dental arch based on the bite registration snapshot and the captured motion data of the second position indicator system:
determining a relative position of the first position indicator system relative to the first dental arch based on the alignment apparatus;
determining a relative position of the second position indicator system relative to the first position indicator system based on the bite registration snapshot;
determining a relative position of the second position indicator system to the first dental arch based on the determined relative position of the second position indicator system to the first position indicator system and determined relative position of the first position indicator system relative to the first dental arch;
determining a relative position of the second dental arch relative to the first dental arch based on the bite registration scan;
determining a relative position of the second position indicator system relative to the second dental arch based on the determined relative position of the second dental arch to the first dental arch and the determined relative position of the second position indicator to the first dental arch; and
determining the motion of the second dental arch based on the determined relative position of the second position indicator system to the second dental arch and the captured motion data of the second position indicator system.
